(19) United States
(12) Patent Application Publication
(10) Pub. No.: US 2003/0162140 A1
(43) Pub. Date: Aug. 28, 2003

(54) Heat-developable image recording material

(76) Inventors: Takayoshi Oyamada, Kanagawa (JP); Itsuo Fujiwara, Kanagawa (JP)

Correspondence Address: BIRCH STEWART KOLASCH & BIRCH, PO BOX 747, FALLS CHURCH, VA, 22040-0747, US

(21) Appl. No.: 10/025,455

(22) Filed: Dec. 26, 2001

(51) Int. Cl. G03C 1/498

(52) U.S. Cl. 430/620; 430/350

(57) ABSTRACT

A heat-developable image recording material comprises a support; a photosensitive silver halide; a reducing agent for a silver ion; a hinder; and a non-photosensitive organic silver salt grain, wherein the non-photosensitive organic silver salt grain has: 1) a silver stearate content of 1 mol % or less; 2) a length/width ratio of 1 to 9; 3) an aspect ratio of 1.1 to 30; and 4) an equivalent-sphere diameter of 0.05 to 1 μm.

### FIELD OF THE INVENTION

The present invention relates to a heat-developable (photothermographic) image recording material having sensitivity to light (hereinafter referred to as “heat-developable photosensitive material”), more specifically, the present invention relates to a heat-developable photosensitive material succeeded in having low Dmin and excellent image storability by characterizing an organic silver salt grain.

### BACKGROUND OF THE INVENTION

Recently, in the field of medical diagnosis film or photomechanical film, the reduction in weight of the processing waste solution is strongly demanded from the standpoint of environmental conservation or space saving. To satisfy this, the technology relating to heat-developable photosensitive materials is demanded to provide a medical diagnosis film or a photomechanical film which can he effectively exposed by means of a laser image setter or a laser imager and which can form a clear black image having high resolution and sharpness. These heat-developable photosensitive materials can offer to customers a simple heat-development processing system not requiring solution-type chemical agents and causing no impairment of the environment.

Although the same is required also in the field of general image-forming materials, the image for medical diagnosis in particular must be finely drawn and therefore, high image quality with excellent sharpness and graininess is needed. Moreover, in view of diagnostic convenience, an image of cold black tone is preferred. At present, various hard copy systems using a pigment or a dye are commercially available as a general image-forming system, such as ink jet printer and electrophotography, however, these are not a satisfactory output system for the medical-use image.

On the other hand, thermographic systems using an organic silver salt are described, for example, in U.S. Pat. Nos. 3,152,904 and 3,457,075, Kosterboer, Thermally Processed Silver Systems, and J. Sturge, V. Walworth and A. Shepp (compilers), Imaging Processes and Materials, 8th ed., Chap. 9, page 279, Neblette (1989). In particular, heat-developable photosensitive materials generally have a photosensitive layer comprising a binder matrix having dispersed therein a catalytic amount of a photocatalyst (for example, silver halide), a reducing agent, a reducible silver salt (for example, organic silver salt) and if desired, a color toner for controlling the silver tone. The heat-developable photosensitive material after image exposure is heated at a high temperature (for example, 80° C. or more) to bring about an oxidation-reduction reaction between the reducible silver salt (acting as an oxidizing agent) and the reducing agent and thereby form a black silver image. The oxidation-reduction reaction is accelerated by the catalytic action of a silver halide latent image produced by the exposure. Therefore, the black silver image is formed in the exposed area. This is disclosed in many publications including U.S. Pat. No. 2,910,377 and JP-B-43-4924 (the term “JP-B” as used herein means an “examined Japanese patent publication”).

In the heat-developable photosensitive material using an organic silver salt, a silver image may come out under light, heat or the like even after a silver image is thermally formed, because the organic silver salt or the like is not fixed. Of course, such a phenomenon does not occur in the normal use range but when the processed film is stored in very severe conditions for the heat-developable photosensitive material, for example, when the film is placed in a car in summer season for the purpose of transportation or the like, there may arise troubles such as discoloration throughout the film or transfer of letters of the bag housing the film onto the film, giving rise to serious problems.

As for the technique to increase the silver behenate content, JP-A-11-271920 (the term “JP-A” as used herein means an “unexamined published Japanese patent application”) describes this in claims, however, the effect on the above-described image storability cannot be obtained with the grain form described in this patent publication.

### SUMMARY OF THE INVENTION

The object of the present invention is to solve those problems in conventional techniques and provide a heat-developable photosensitive material ensuring low Dmin and excellent image storability.

The object of the present invention can be attained by the following means. That is,

<1> A heat-developable image recording material comprising:

a support;

a photosensitive silver halide;

a reducing agent for a silver ion;

a binder; and

a non-photosensitive organic silver salt grain,

wherein the non-photosensitive organic silver salt grain has:

1) a silver stearate content of 1 mol % or less;

2) a length/width ratio of 1 to 9;

3) an aspect ratio of 1.1 to 30; and

4) an equivalent-sphere diameter of 0.05 to 1 μm.

<2> The heat-developable image recording material as described in item <1>, wherein the non-photosensitive organic silver salt grain has a silver arachidate content of 6 mol % or less.

<3> The heat-developable image recording material as described in item <1>, wherein the non-photosensitive organic silver salt grain has a silver behenate content of 90 to 100 mol %.

<4> The heat-developable image recording material as described in item <1>, wherein the non-photosensitive organic silver salt grain has a silver behenate content of 95 to 100 mol %.

<5> The heat-developable image recording material as described in item <1>, wherein the non-photosensitive organic silver salt grain has a silver behenate content of 97 to 100 mol %.

<6> The heat-developable image recording material as described in item <1>, wherein the non-photosensitive organic silver salt grain is prepared at 60° C. or less.

<7> The heat-developable image recording material as described in item <1>, wherein the non-photosensitive organic silver salt grain is prepared by adding an aqueous silver nitrate solution and a solution or suspension of an organic acid alkali metal salt to a closed mixing vessel.

<8> The heat-developable image recording material as described in item <1>, wherein the non-photosensitive organic silver salt grain is desalted by an ultrafiltration.

<9> The heat-developable image recording material as described in item <1>, which further comprises an image-forming layer containing the photosensitive silver halide and the non-photosensitive organic silver salt grain.

<10> The heat-developable image recording material as described in item <9>, wherein the image-forming layer further contains the reducing agent for a silver ion and the binder.

<11> The heat-developable image recording material as described in item <9>, which further comprises a second image-forming layer containing the reducing agent for a silver ion and the binder.

### BRIEF DESCRIPTION OF THE DRAWING

FIG. 1 shows one practical embodiment of an apparatus for producing non-photosensitive organic silver salt for use in the present invention.

The reference numbers in the figure are as follows.

11: TANK

12: TANK

13: FLOWMETER

14: FLOWMETER

15: PUMP

16: PUMP

17: PUMP

18: MIXING DEVICE

19: HEAT EXCHANGER

20: TANK

### DETAILED DESCRIPTION OF THE INVENTION

The present invention is described in detail below.

The non-photosensitive organic silver salt (hereinafter sometimes simply referred to as “organic silver salt”) which can be used in the present invention is relatively stable to light but forms a silver image when heated at 80° C. or more in the presence of an exposed photocatalyst (e.g., a latent image of photosensitive silver halide) and a reducing agent. The organic silver salt may be an arbitrary organic substance containing a source capable of reducing silver ion. Such a non-photosensitive organic silver salt is described in JP-A-06-130543, JP-A-08-314078, JP-A-09-127643, JP-A-10-62899 (paragraphs 0048 to 0049), JP-A-10-94074, JP-A-10-94075, EP-A-0803764 (page 18, line 24 to page 19, line 37), EP-A-0962812, EP-A-1004930, JP-A-11-349591, JP-A-2000-7683, JP-A-2000-72711, JP-A-2000-112057 and JP-A-2000-155383.

The organic silver salt is preferably a silver salt of an organic acid, particularly a silver salt of a long chain aliphatic carboxylic acid (having from 10 to 30 carbon atoms, preferably from 15 to 28 carbon atoms). Preferred examples of the organic silver salt include silver behenate, silver arachidate, silver stearate and mixtures thereof. In the present invention, as characteristic features, the silver stearate content is 1 mol % or less and by having such a content, low Dmin can be attained and the obtained silver salt of organic acid can exhibit excellent image storability. The silver stearate content is preferably 0.5 mol % or less and it is more preferred that silver stearate is substantially not contained. The silver arachidate content is, from the standpoint of obtaining low Dmin and a silver salt of organic acid having excellent image stability, preferably 6 mol % or less, more preferably 3 mol % or less. And, the silver behenate content is, for obtaining low Dmin and a silver salt of organic acid having excellent image stability, preferably 90 mol % or more, more preferably 95 mol % or more, still more preferably 97 mol % or more.

The organic silver salt which can be used in the present invention is a grain characterized by having a flake-like shape with a length/width ratio of 1 to 9. With a length/width ratio in the range from 1 to 9, crushing of grains does not occur and good image storability is advantageously yielded.

In the present invention, the flake-like organic silver salt and the length/width ratio are defined as follows. An organic silver salt is observed through an electron microscope, the shape of the organic silver salt grain is approximated to a rectangular parallelopiped, and assuming that the sides of the rectangular parallelopiped are a, b and c from the shortest side (c and b can be equal), x and y are calculated and determined from the smaller numerical values a and b according to the following formulae:

x=b/a

y=c/b

In this way, x and y of about 200 grains are determined and assuming that the mean value thereof is x (average), those satisfying the relationship of x (average)≧1.5 are defined as the flake-like grain. The relationship is preferably 30≧x (average)≧1.5, more preferably 20≧x (average)≧2.0. Incidentally, in the case of acicular grain, 1≦x (average)≦1.5. The mean value y (average) thereof is defined as the length/width ratio. The organic silver salt grain which is a grain for use in the present invention is characterized by having a length/width ratio of 1 to 9. The length/width ratio is preferably from 1 to 6, more preferably from 1 to 3.

In the flake-like grain, a can be regarded as the thickness of a tabular grain where the plane having sides b and c is the main plane. The average of a is preferably from 0.01 to 0.23 μm, more preferably from 0.1 to 0.20 pp.

In the flake-like grain the equivalent-sphere diameter/a of the grain is defined as the aspect ratio. The aspect ratio of a flake-like grain for use in the present invention is preferably from 1.1 to 30. with an aspect ratio in this range, coagulation of the grains is difficult to occur in a photosensitive material and good image storability is obtained. The aspect ratio is preferably from 1.1 to 15.

The flake-like grain for use in the present invention is characterized by having an equivalent-sphere diameter of 0.05 to 1 μm and with this equivalent-sphere diameter, coagulation of the grains is difficult to occur in a photosensitive material and good image storability is obtained. The equivalent-sphere diameter is preferably from 0.1 to 1 μm. In the present invention, the equivalent-sphere diameter can be measured by directly photographing a sample using an electron microscope and thereafter subjecting the negative film to image processing.

The grain size distribution of the organic silver salt is preferably monodisperse. The term “monodisperse” means that when a standard deviation of the volume weighed average diameter of organic silver salt gains is obtained and the standard deviation is divided by the volume weighed average diameter, the obtained value in percentage is preferably 100% or less, nore preferably 80% or less, still more preferably 50% or less. This may be determined from the grain size (volume weighed average diameter) obtained, for example, by irradiating laser light to organic silver salt grains dispersed in liquid and determining the auto-correlation function of the fluctuation of scattering light relative to the time change.

The organic silver salt grain for use in the present invention is preferably prepared at a reaction temperature of 60° C. or less from the standpoint of preparing grain having low Dmin. The temperature of chemicals added, for example, an aqueous solution of an organic acid alkali metal may be higher than 60° C., however, the temperature of the reaction bath to which the reaction solution is added is preferably 60° C. or less, more preferably 50° C. or less, still more preferably 40° C. or less.

The organic silver salt grain for use in the present invention can be prepared by reacting a solution containing silver ion such as silver nitrate with a solution or suspension of an organic acid alkali metal salt and at this preparation, 50% or more of the total amount of silver added is preferably added simultaneously with the addition of the solution or suspension of an organic acid alkali metal salt. The addition may be made to the liquid surface at the reaction bath, to the liquid or to the closed mixing means which is described later.

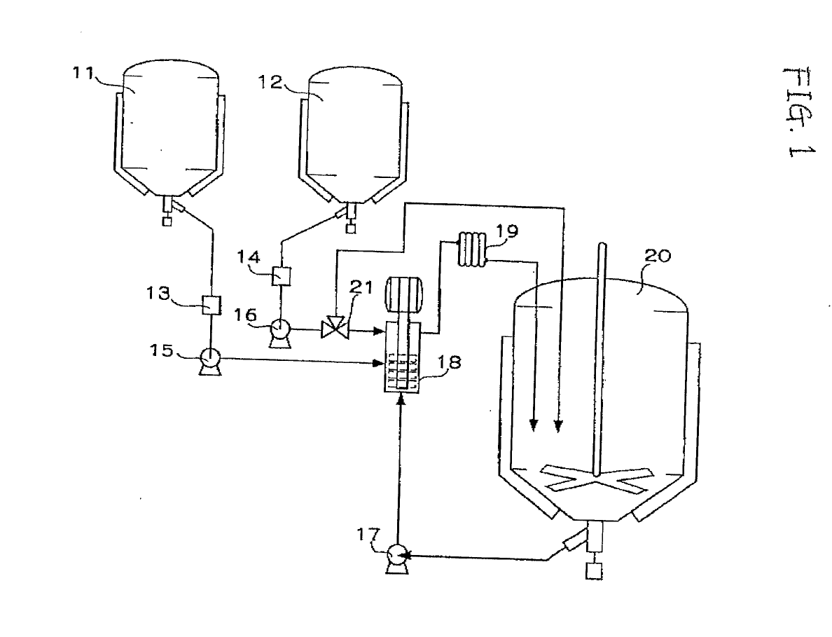

One example of the preparation method using the addition to a closed mixing means is described below, however, the present invention is not limited thereto. FIG. 1 shows one practical embodiment of an apparatus for producing the non-photosensitive silver salt for use in the present invention. In the Figure, tanks 11 and 12 are tanks for storing a silver ion-containing solution (for example, an aqueous silver nitrate solution) and an organic alkali metal salt solution, respectively, at a predetermined temperature; and 13 and 14 are flowmeters for measuring the flow rates of these solutions which are added through pumps 15 and 16 to a closed mixing device 18 filled with a liquid. In this practical embodiment, a pump 17 is provided for again feeding the prepared organic silver salt dispersion as the third component to the mixing device 18. After the completion of reaction, the liquid in the mixing device 18 is introduced into a heat exchanger 19 and swiftly cooled.

The pH of the silver ion-containing solution (for example, an aqueous silver nitrate solution) for use in the present invention is preferably from 1 to 6, more preferably from 1.5 to 4. For adjusting the pH, an acid and an alkali may be added. The kinds of acid and alkali are not particularly limited.

After the completion of addition of a silver ion-containing solution (for example, an aqueous silver nitrate solution) and/or an organic acid alkali metal salt solution, the organic silver salt for use in the present invention may be ripened by elevating the reaction temperature. In the present invention, the ripening temperature is different from the above-described reaction temperature. At the ripening, silver nitrate and a solution or suspension of an organic acid alkali metal salt are not added at all. The ripening temperature is preferably (reaction temperature+from 1 to 20° C.), more preferably (reaction temperature+from 1 to 10° C.). The ripening time is preferably determined by trial and error.

In the present invention, the preparation of the organic silver salt may be performed by adding the organic acid alkali metal salt solution in parts of 2 to 6 times. By the addition in parts, various functions may be added to grains, for example, addition for enhancing the photographic performance or addition for changing the hydrophilicity on the surface. The number of divided additions is preferably from 2 to 4 times. At the addition in parts, since the organic acid salt solidifies unless the temperature is high, it must be considered to provide a plurality of lines for the divided addition or employ a circulation system.

In the preparation of the organic silver salt for use in the present invention, from 0.5 to 30 mol % of the total added molar number of the organic acid alkali metal salt solution is preferably added alone after the completion of addition of the silver ion-containing solution. Preferably, from 3 to 20 mol % is added alone. One of the above-described divided additions is preferably this sole addition. This sole addition may be made to either the closed mixing means or the reaction tank but is preferably made to the reaction tank. By this sole addition, the hydrophilicity on the grain surface can be elevated, as a result, the photosensitive material can have good film-forming property and the film cracking can be improved.

The silver ion concentration of the silver ion-containing solution (for example, an aqueous silver nitrate solution) for use in the present invention may be freely selected but is preferably, in terms of the molar concentration, from 0.03 to 6.5 mol/L, more preferably from 0.1 to 5 mol/L.

In the present invention, for forming organic acid grains, an organic solvent is preferably added to at least one of the silver ion-containing solution, the solution or suspension of an organic acid alkali metal salt and the solution previously prepared in the reaction site, in an amount sufficiently large to allow the alkali metal salt of organic acid to form a substantially transparent solution but not to form stringed aggregates or micelles. The organic solvent may be used by itself but is preferably used as a mixed solution with water.

The organic solvent for use in the present invention is not particularly limited on the kind thereof insofar as it has the above-described properties, however, those which inhibit the photographic performance are not preferred. The organic solvent is preferably alcohol or acetone which can be mixed with water, more preferably tertiary alcohol having from 4 to 6 carbon atoms.

The alkali metal in the alkali metal salt of organic acid is preferably, to speak specifically, Na or K. The alkali metal salt of organic acid can be prepared by adding NaOH or KOH to an organic acid. At this time, it is preferred to allow unreacted organic acid to remain by setting the amount of alkali equivalent to or less than the amount of organic acid. The amount of residual organic acid is from 3 to 50 mol %, preferably from 3 to 30 mol %, based on all organic acids. The amount of residual organic acid may also be adjusted by adding an alkali in excess of the desired amount and thereafter adding an acid such as nitric acid or sulfuric acid to neutralize the excess alkali content.

The silver ion-containing solution or the organic acid alkali metal salt solution for use in the present invention or the solution within the closed mixing vessel to which those two solutions are added may contain, for example, a compound represented by formula (1) of JP-A-62-65035, a water-soluble group-containing N-heterocyclic compound described in JP-A-62-150240, an inorganic peroxide described in JP-A-50-101019, a sulfur compound descried in JP-A-51-78319, a disulfide compound described in JP-A-57-643 or a hydrogen peroxide.

The amount of the organic solvent for the organic acid alkali metal salt solution used in the present invention is preferably, in terms of the solvent volume, from 3 to 70%, more preferably from 5 to 50%, based on the volume of water content. Here, the optimal solvent volume varies depending on the reaction temperature and therefore, the optimal amount may be determined by trial and error.

The concentration of the organic acid alkali metal salt for use in the present invention is, in terms of the weight ratio, from 5 to 50 wt %, preferably from 7 to 45 wt %, more preferably from 10 to 40 wt %.

The temperature of the tertiary alcohol aqueous solution of organic acid alkali metal salt added to the closed mixing means or the reactor is preferably from 50 to 90° C., more preferably from 60 to 85° C., most preferably from 65 to 85° C., so as to maintain the temperature necessary for preventing crystallization or solidification of the organic acid alkali metal salt. Also, for controlling the reaction to a constant temperature, the solution is preferably controlled to a constant temperature selected from the above-described range.

By this control, the speed when the tertiary alcohol aqueous solution of the organic acid alkali metal salt at a high temperature is rapidly cooled and precipitated in the form of fine crystal and the speed when an organic silver salt is formed by the reaction with the silver ion-containing solution can be properly controlled, so that the organic silver salt can be controlled to have preferred crystal form, crystal size and crystal size distribution and in turn, the heat-developable material using this crystal, particularly the heat-developable photosensitive material, can be more improved in the performance.

A solvent may be previously contained in the reactor and the solvent previously contained is preferably water but a mixed solvent with the above-described tertiary alcohol is also preferred.

The tertiary alcohol aqueous solution of organic acid alkali metal, the ion-containing solution or the reaction solution may contain a dispersion aid which is soluble in an aqueous medium. Any dispersion aid may be used insofar as it can disperse the formed organic silver salt. Specific examples are the same as those described later for the dispersion aid of the organic silver salt.

In the preparation process of the organic silver salt, a step of performing desalting/dehydration is preferably provided after the formation of silver salt. The method therefor is not particularly limited and a known and commonly employed means can be used. For example, a known filtration method such as centrifugal filtration, suction filtration, ultrafiltration or flocculation/water washing by coagulation, or a method of removing the supernatant after centrifugal separation and precipitation is preferably used. The desalting/dehydration may be performed only once or may be repeated multiple times. The addition and removal of water may be performed continuously or individually. The desalting/dehydration is performed to such an extent that the finally dehydrated water preferably has a conductivity of 300 μS/cm or less, more preferably 100 μS/cm or less, most preferably 60 μS/cm or less. The lower limit of the conductivity is not particularly limited but is usually about 5 μS/cm.

In the ultrafiltration method, a method used, for example, in the desalting/concentration of silver halide emulsion may be applied. This is described in Research Disclosure, No. 10 208 (1972), No. 13 122 (1975) and No. 16 351 (1977). The pressure difference and flow rate which are important operation conditions may be selected by referring to the characteristic curve described in Haruhiko Oya, Maku Riyo Gijutsu Handbook (Handbook for Membrane Using Technology), Saiwai Shobo Shuppan, page 275 (1978), however, in treating an objective organic silver salt dispersion, optimal conditions must be found out for preventing the coagulation or fogging of grains. The method of replenishing the solvent lost upon passing through a membrane include a constant-volume system of continuously adding the solvent and a batch system of discontinuously adding the solvent in parts and of these, the constant-volume system is preferred because the desalting time is relatively short.

For the solvent thus replenished, ion-exchanged water or pure water obtained by distillation is used. In order to keep an objective pH, a pH adjusting agent or the like may be mixed in the pure water or may be added directly to the organic silver salt dispersion.

As for the ultrafiltration membrane, a plate type, a spiral type, a cylinder type, a hollow yarn type and a hollow fiber type, which have already integrated therein as a module, are commercially available from Asahi Chemical Industry Co., Ltd., Daicel Chemical Industries, Ltd., Toray Industries, Inc., Nitto Electric Industrial Co., Ltd. and the like. In view of the total membrane area and the washing property, the spiral type and the hollow yarn type are preferred.

The fractional molecular weight as an index of the threshold value for components which can pass through the membrane is preferably ⅕ or less of the molecular weight of the polymer dispersant used.

In the desalting by ultrafiltration according to the present invention, it is preferred to disperse the solution to a grain size about 2 times the final grain size in terms of the volume weighed mean, in advance of the treatment. The dispersion may be performed using any means such as high-pressure homogenizer or micro-fluidizer.

During the time period from the grain formation until the desalting operation starts, the liquid temperature is preferably maintained low, because in the state where the organic solvent used in dissolving the alkali metal salt of organic acid is penetrated into the inside of the produced organic silver salt grains, silver nuclei are readily produced in the shearing site or pressure site at the liquid feeding operation or on passing through the ultrafiltration membrane. Accordingly, in the present invention, the ultrafiltration operation is performed while keeping the organic silver salt grain dispersion at a temperature of 1 to 30° C., preferably from 5 to 25° C.

Furthermore, in order to impart good coated surface state to a heat-developable material, particularly a heat-developable photosensitive material, the desalted and dehydrated organic silver salt is preferably formed into a fine dispersion by adding and dispersing a dispersant.

In the production and dispersion of the organic silver salt for use in the present invention, known methods can be applied. These methods are described, for example, in JP-A-8-234358 supra, JP-A-10-62899, EP-A-0803763, EP-A-0962812, JP-A-11-349591, JP-A-2000-7683, JP-A-2000-72711, JP-A-2000-53682, JP-A-2000-75437, JP-A-2000-86669, JP-A-2000-143578, JP-A-2000-178278, JP-A-2000-256254 and Japanese Patent Application Nos. 11-348228 to 11-348230, 11-203413, 11-115457, 11-180369, 11-297964, 11-157838, 11-202081, 2000-90093, 2000-195621, 2000-191226, 2000213813, 2000-214155 and 2000-191226.

The organic silver salt may be finely dispersed by mechanically dispersing it using known pulverizing means (for example, high-speed mixer, homogenizer, high-speed impact mill, Banbury mixer, homomixer, kneader, ball mill, vibration ball mill, planetary mill, attritor, sand mill, beads mill, colloid mill, jet mill, roller mill, thoron mill and high-speed stone mill) in the presence of a dispersion aid.

For obtaining a uniform fatty silver salt solid dispersion having a high S/N and a small grain size and being free of coagulation, a large power is preferably given uniformly within the range of not causing breakage of organic silver salt grains as an image formation medium or elevation of the temperature. For this purpose, a dispersion method of converting a dispersion comprising the organic silver salt and a dispersant solution into a high-speed flow and then decreasing the pressure is preferably used. The dispersion medium used here may be any substance insofar as the dispersion aid can function in the solvent but is preferably water alone or water containing an organic solvent in an amount of 20 wt % or less. If a photosensitive silver salt is present together at the dispersion, fog increases and sensitivity seriously decreases. Therefore, it is preferred to contain substantially no photosensitive silver salt at the dispersion. In the present invention, the amount of the photosensitive silver salt in the dispersion solution where the photosensitive silver salt is dispersed is 0.1 mol % or less per mol of the organic silver salt in the solution and the photosensitive silver salt is preferably not added.

The dispersing apparatus used in practicing the above-described re-dispersion method and techniques thereon are described in detail, for example, in Toshio Kajiuchi and Hiromoto Usui, Bunsan-Kei Rheology to Bunsan-Ka Gijutsu(Dispersion System Rheology and Dispersion Technology), pp. 357-403, Shinzan-Sha Shuppan K.K. (1991), Kagaku Kogaku Kai Tokai Shibu (compiler), Kagaku Kogaku no Shimpo Dai 24 Shu (Progress of Chemical Engineering, No. 24), pp. 184-185, Maki Shoten (1990), JP-A-59-49832, U.S. Pat. No. 4,533,254, JP-A-8-137044, JP-A-8-238848, JP-A-2-261525 and JP-A-1-94933. In the present invention, the re-dispersion is performed by a method where a dispersion solution containing at least the organic silver salt is pressurized into a pipeline using a high-pressure pump or the like and passed through a thin slit provided within the pipeline, and thereafter, the pressure on the dispersion solution is abruptly reduced, thereby finely dispersing the solution.

In the high-pressure homogenizer, it is considered that (a) the “shearing force” generated upon passing of the dispersoid through a narrow opening (approximately from 75 to 350 μm) at a high speed under a high pressure and (b) the impact force generated at the liquid-liquid collision in a narrow space under a high pressure or at the collision against the wall surface are generally not changed but the cavitation force due to the pressure reduction occurred thereafter is more intensified and thereby uniform and highly efficient dispersion can be attained. As the dispersing apparatus of this type, Gaulin homogenizer is long known. In this homogenizer, the solution to be dispersed, which is transferred under a high pressure, is converted into a high-speed flow in the narrow opening on the cylindrical face, the farce generated there enforces the solution to collide against the peripheral wall surface, and the impact force generated allows the emulsification and dispersion to proceed. Examples of the liquid-liquid collision-type apparatus include the Y-type chamber of microfluidizer and a spherical chamber using a spherical check valve described in JP-A-8-103642 which is described later, and examples of the liquid-wall surface collision-type apparatus include the Z-type chamber of microfluidizer. The pressure used is generally from 100 to 600 kg/cm² (from 1 to 6 MPa) and the flow rate is from a few m to 30 m/sec. Some apparatuses are designed to increase the collision frequency by forming the high-speed flow part in the serrated shape and thereby increase the dispersion efficiency. Representative examples of the apparatus of this type include Gaulin homogenizer, the microfluidizer manufactured by Microfluidex International Corporation, the microfluidizer manufactured by Mizuho Kogyo K.K., and the nanomizer manufactured by Tokushu Kika Kogyo K.K. The apparatuses are also described in JP-A-8-238848, JP-A-8-103642 and U.S. Pat. No. 4,533,254.

The organic acid silver salt can be dispersed to a desired grain size by controlling the flow rate, the pressure difference at the pressure drop, and the treatment frequency, however, in view of the photographic properties and the grain size, it is preferred that the flow rate is from 200 to 600 m/sec and the pressure difference at the pressure drop is from 900 to 3,000 kg/cm² (from 9 to 30 MPa), more preferably that the flow rate is from 300 to 600 m/sec and the pressure difference at the pressure drop is from 1,500 to 3,000 kg/cm² (15 to 30 MPa). The dispersion treatment frequency may be selected according to the necessity. The dispersion treatment frequency is usually from 1 to 10 times but in view of the productivity, it is preferably from 1 to 3 times. If the temperature of this dispersion solution is elevated under a high pressure, the dispersibility and the photographic properties are adversely affected. More specifically, if the temperature exceeds 90° C., a large grain size is liable to result and the fog readily increases. Therefore, it is preferred to contain a cooling device in the process before the conversion into a high-pressure and high-speed flow, in the process after the pressure drop or in these two processes and maintain the dispersion at a temperature of 5 to 90° C., more preferably from 5 to 80° C., still more preferably from 5 to 65° C., by such a cooling device. At the dispersion operation under a high pressure of 1,500 to 3,000 kg/cm² (from 15 to 30 MPa), the cooling device thus disposed is particularly effective. The cooling device may be appropriately selected according to the required heat exchanging amount from a cooling device using a static mixer for the double or triple pipe, a tubular heat exchanger and a coiled heat exchanger. Furthermore, by taking account of the pressure used, those having suitable pipe size, wall thickness or constructive material may be selected so as to increase the efficiency of heat exchanging. In view of the heat exchanging amount, the refrigerant used in the cooler is well water at 20° C. or chilled water treated by a refrigerator to 5 to 10° C. Also, if desired, a refrigerant at −30° C., such as ethylene glycol/water, may be used.

In forming the organic silver salt into solid fine grains using a dispersant, a synthetic anion polymer such as polyacrylic acid, acrylic acid copolymer, maleic acid copolymer, maleic acid monoester copolymer and acryloyl-methylpropanesulfonic acid copolymer, a semisynthetic anion polymer such as carboxymethyl starch and carboxymethyl cellulose, an anionic polymer such as alginic acid and pectic acid, an anionic surfactant described in J7-A-52-92716 and WO88/04794, a compound described in Japanese Patent Application No. 7-350753, a known anionic, nonionic or cationic surfactant, a known polymer such as polyvinyl alcohol, polyvinylpyrrolidone, carboxymethyl cellulose, hydroxypropyl cellulose and hydroxypropylmethyl cellulose, or a naturally occurring polymer compound such as gelatin, may be appropriately selected and used. In the case of using a solvent as the dispersion medium, preferred examples of the Solvent include polyvinyl butyral, butyl ethyl cellulose, methacrylate copolymers, maleic anhydride ester copolymers, polystyrene, and butadiene-styrene copolymers.

According to a general method, the dispersion aid is mixed with the organic silver salt in the powder form or in the wet cake state before the dispersion and fed as a slurry to a disperser. The dispersion aid may be previously mixed with the organic acid silver salt and then heat-treated or treated with a solvent to form an organic acid silver salt powder or wet cake. Before, after or during the dispersion, the pH may be controlled using an appropriate pH adjusting agent.

Other than the mechanical dispersion, a method of crudely dispersing the organic silver salt in a solvent by controlling the pH and thereafter varying the pH in the presence of a dispersion aid to form fine grains may also be employed. At this time, a fatty acid solvent may be used as the solvent for the crude dispersion.

If a photosensitive silver salt is present together at the dispersion, fog increases and sensitivity seriously decreases. Therefore, it is preferred to contain substantially no photosensitive silver salt at the dispersion. In the present invention, the amount of the photosensitive silver salt in a water dispersion where the photosensitive silver salt is dispersed is 0.1 mol % or less per mol of the organic silver salt in the solution and the photosensitive silver salt is not positively added.

In the present invention, a photosensitive material can be produced by mixing the organic silver salt water dispersion and the photosensitive silver salt water dispersion and the mixing ratio of the organic silver salt to the photosensitive silver salt can be selected according to the purpose, however, the ratio of the photosensitive silver salt to the organic silver salt is preferably from 1 to 30 mol %, more preferably from 3 to 20 mol %, still more preferably from 5 to 15 mol %. A method of using two or more organic silver salt water dispersions and two or more photosensitive silver salt water dispersions at the mixing is preferably employed for controlling the photographic properties.

The organic silver salt for use in the present invention may be used in any desired amount, however, the amount in terms of silver is preferably from 0.1 to 5 g/m², more preferably from 1 to 3 g/m².

The heat-developable photosensitive material of the present invention preferably contains a reducing agent for the organic silver salt. The reducing agent for the organic silver salt may be any substance (preferably an organic material) capable of reducing silver ion into metal silver. Such a reducing agent is described in JP-A-11-65021 (paragraph Nos. 0043 to 0045) and EP-A-0803764 (page 7, line 34 to page 18, line 12).

In the present invention, the reducing agent is preferably a hindered phenol reducing agent or a bisphenol reducing agent, more preferably a compound represented by the following formula (I):

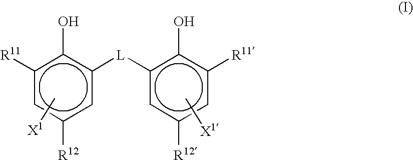

wherein R¹¹ and R¹¹′ each independently represents an alkyl group having from 1 to 20 carbon atoms; R¹² and R¹²′ each independently represents a hydrogen atom or a substituent capable of substituting to the benzene ring; L represents—S— group or —CHR¹³— group; R¹³ represents a hydrogen atom or an alkyl group having from 1 to 20 carbon atoms; and X¹ and X¹′ each independently represents a hydrogen atom or a group capable of substituting to the benzene ring.

Formula (I) is described in detail.

R¹¹ and R¹¹′ each represents a substituted or unsubstituted alkyl group having from 1 to 20 carbon atoms. The substituent of the alkyl group is not particularly limited but preferred examples thereof include an aryl group, a hydroxy group, an alkoxy group, an aryloxy group, an alkylthio group, an arylthio group, an acylamino group, a sulfonamido group, a sulfonyl group, a phosphoryl group, an acyl group, a carbamoyl group, an ester group and a halogen atom.

R¹² and R¹²′ each independently represents a hydrogen atom or a substituent capable of substituting to the benzene ring, and X¹ and X¹′ each independently represents a hydrogen atom or a group capable of substituting to the benzene ring. Preferred examples of respective groups capable of substituting to the benzene ring include an alkyl group, an aryl group, a halogen atom, an alkoxy group and an acylamino group.

L represents —S— group or —CHR¹³— group. R¹³ represents a hydrogen atom or an alkyl group having from 1 to 20 carbon atoms and the alkyl group may have a substituent. Specific examples of the unsubstituted alkyl group represented by R¹³ include a methyl group, an ethyl group, a propyl group, a butyl group, a heptyl group, a undecyl group, an isopropyl group, a 1-ethylbenzyl group and 2,4,4-trimethylpentyl group. Examples of the substituent of the alkyl group are the same as the substituent of R¹¹ and include a halogen atom, an alkoxy group, an alkylthio group, an aryloxy group, an arylthio group, an acylamino group, a sulfonamido group, a sulfonyl group, a phosphoryl group, an oxycarbonyl group, a carbamoyl group and a sulfamoyl group.

R¹¹ and R¹¹′ is preferably a secondary or tertiary alkyl group having from 3 to 15 carbon atoms and examples thereof an isopropyl group, an isobutyl group, a tert-butyl group, a tert-amyl group, a tert-octyl group, a cyclohexyl group, a cyclopentyl group, 1-methylcyclohexyl group and a 1-methylcyclopropyl group. R¹¹ and R¹¹′ each is preferably a tertiary alkyl group having from 4 to 12 carbon atoms, more preferably a tert-butyl group, a, tert-amyl group or a 1 methylcyclohexyl group, most preferably a tert-butyl group.

R¹² and R¹²′ each preferably an alkyl group having from 1 to 20 carbon atoms and examples thereof include a methyl group, an ethyl group, a propyl group, a butyl group, an isopropyl group, a tert-butyl group, a tert-amyl group, a cyclohexyl group, a 1-methylcyclohexyl group, a benzyl group, a methoxymethyl group and a methoxyethyl group. Among these, more preferred are a methyl group, an ethyl group, a propyl group, an isopropyl group and a tert-butyl group.

X¹ and X¹′ each is preferably a hydrogen atom, a halogen atom or an alkyl group, more preferably a hydrogen atom.

L is preferably —CHR¹³— group.

R¹³ is preferably a hydrogen atom or an alkyl group having from 1 to 15 carbon atoms and the alkyl group is preferably a methyl group, an ethyl group, a propyl group, an isopropyl group or a 2,4,4-trimethylpentyl group, more preferably a hydrogen atom, a methyl group, a propyl group or an isopropyl group.

When R¹³ is a hydrogen atom, R¹² and R¹²′ each is preferably an alkyl group having from 2 to 5 carbon atoms, more preferably an ethyl group or a propyl group, most preferably an ethyl group.

When R¹³ is a primary or secondary alkyl group having from 1 to 8 carbon atoms, R¹² and R¹²′ each is preferably a methyl group. The primary or secondary alkyl group having from 1 to 8 carbon atoms represented by R¹³ is preferably a methyl group, an ethyl group, a propyl group or an isopropyl group, more preferably a methyl group, an ethyl group or a propyl group.

When R¹¹, R¹¹′, R¹² and R¹²′ all are a methyl group, R¹³ is preferably a secondary alkyl group. In this case, the secondary alkyl group represented by R¹³ is preferably an isopropyl group, an isobutyl group or a 1-ethylpentyl group, more preferably an isopropyl group.

Specific examples of the reducing agent for use in the present invention including the compound represented by formula (I) are set forth below, however, the present invention is not limited thereto.

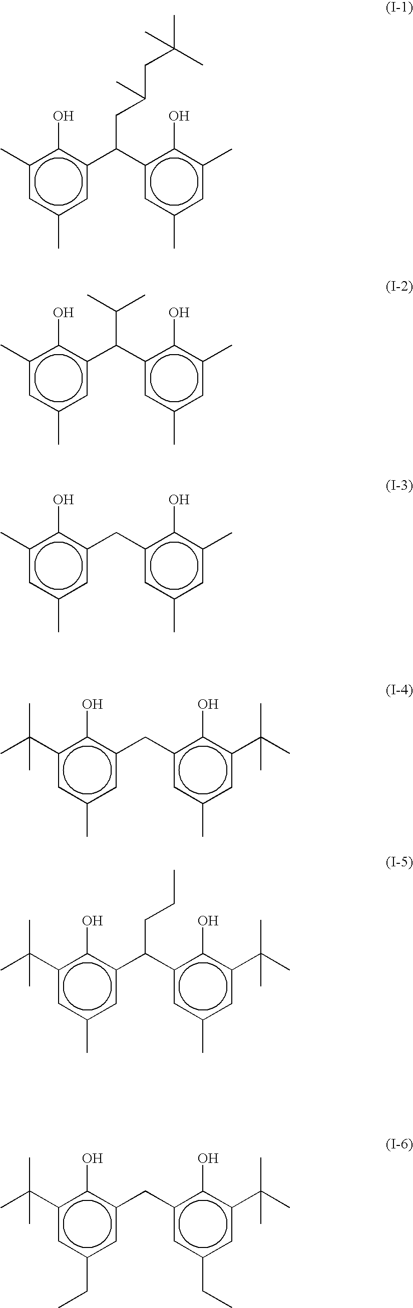

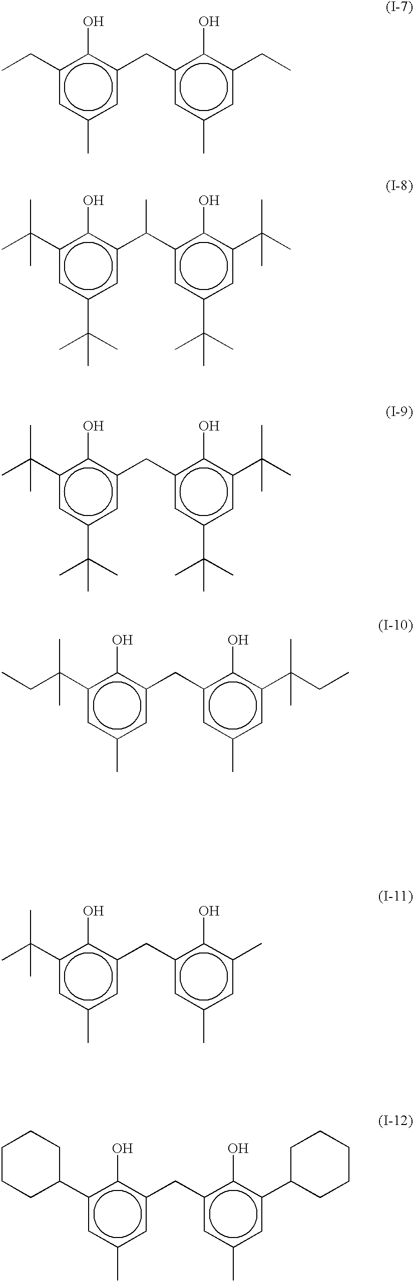

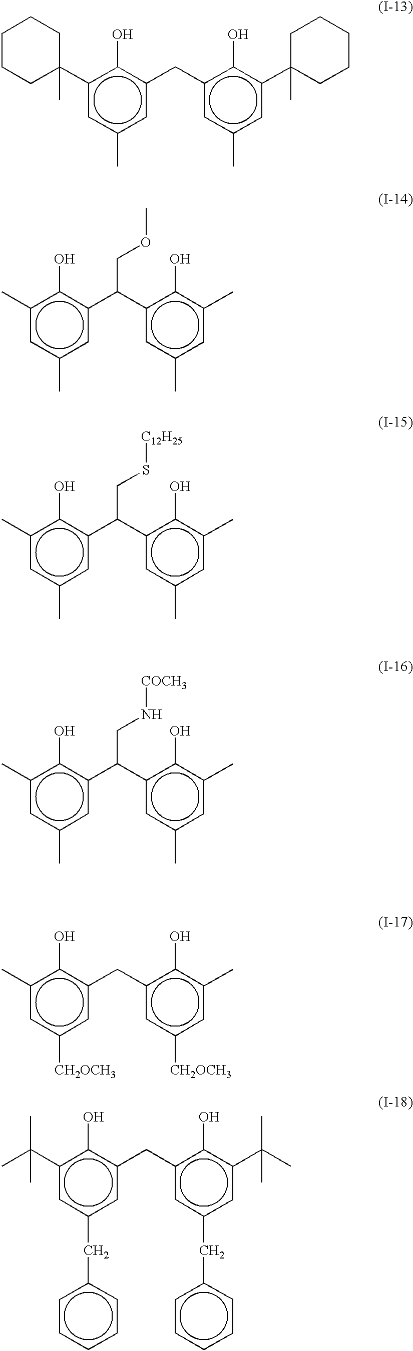

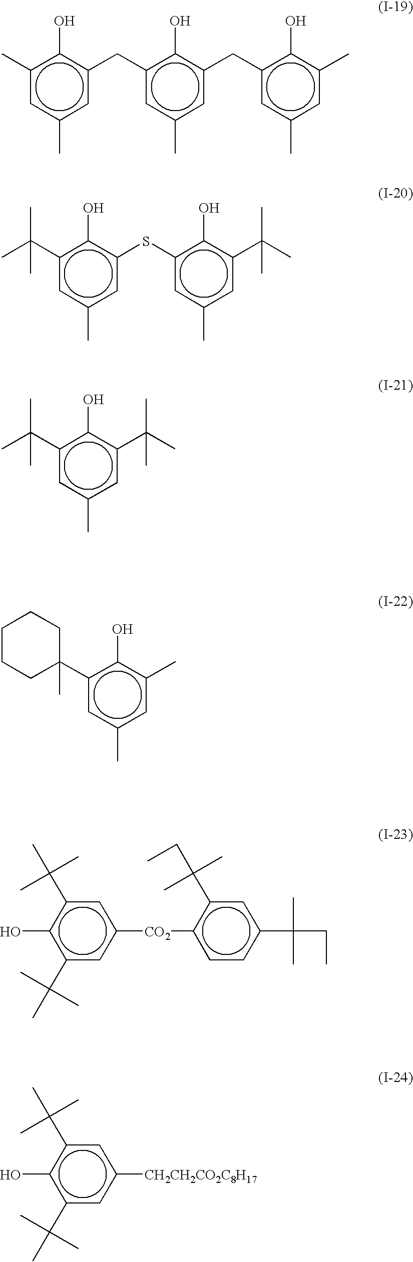

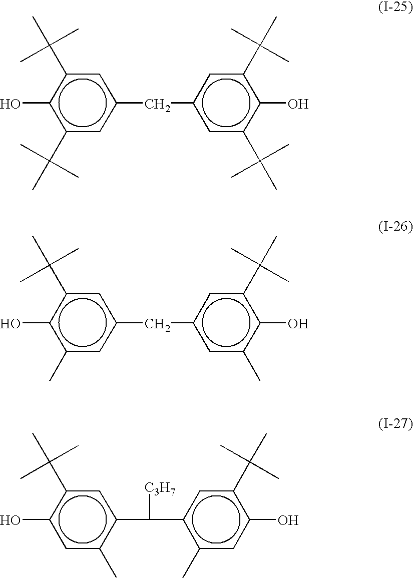

In the present invention, the reducing agent is preferably added in an amount of 0.01 to 5 g/m², more preferably from 0.1 to 3.0 g/m², and preferably contained in an amount of 5 to 50 mol %, more preferably from 10 to 40 mol %, per mol of silver on the surface side having an image forming layer. The reducing agent is preferably contained in an image forming layer.

The reducing agent may be contained in the coating solution or incorporated into the photosensitive material in any form, for example, in the form of a solution, an emulsified dispersion or a solid fine grain dispersion.

Examples of the well-known emulsification dispersion method include a method of dissolving the reducing agent using an oil such as dibutyl phthalate, tricresyl phosphate, glyceryl triacetate or diethyl phthalate, or an auxiliary solvent such as ethyl acetate or cyclohexanone, and mechanically manufacturing an emulsified dispersion.

Examples of the solid fine grain dispersion method include a method of dispersing the reducing agent in the powder form in an appropriate solvent such as water using a ball mill, a vibrating ball mill, a sand mill, a jet mill, a roller mill or an ultrasonic wave, thereby manufacturing a solid dispersion. At this time, a protective colloid (e.g., polyvinyl alcohol) or a surfactant (for example, an anionic surfactant such as sodium triisopropylnaphthalenesulfonate (a mixture where three isopropyl groups are substituting to different positions)) may be used. In the case of a water dispersion, an antiseptic (e.g., benzoisothiazolinone sodium salt) may be incorporated into the dispersion.

In the heat-developable photosensitive material of the present invention, a phenol derivative represented by formula (A) described in Japanese Patent Application No. 11-73951 is preferably used as a development accelerator.

In the case where the reducing agent for use in the present invention has an aromatic hydroxyl group (—OH), particularly, in the case of a bisphenol described above, a non-reducing compound having a group capable of forming a hydrogen bond with the hydroxyl group or amino group is preferably used in combination. Examples of the group capable of forming a hydrogen bond with the hydroxyl group or amino group include a phosphoryl group, a sulfoxide group, a sulfonyl group, a carbonyl group, an amido group, an ester group, a urethane group, a ureido group, a tertiary amino group and a nitrogen-containing aromatic group. Among these, preferred are the compounds having a phosphoryl group, a sulfoxide group, an amido group (provided that this does not have a >N—H group but is blocked like >N—Ra (wherein Ra is a substituent excluding H)), a urethane group (provided that this does not have a >N—H group but is blocked like —N—Ra (wherein Ra is a substituent excluding H)) or a ureido group (provided that this does not have a >N—H group but is blocked like —N—Ra (wherein Ra is a substituent excluding H)).

In the present invention, the hydrogen bond-forming compound is particularly preferably a compound represented by the following formula (II):

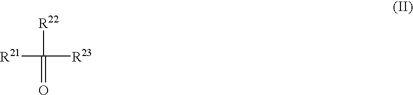

In formula (II), R²¹ to R²³ each independently represents an alkyl group, an aryl group, an alkoxy group, an aryloxy group, an amino group or a heterocyclic group, and each may be unsubstituted or may have a substituent. When R²¹ to R²³ each have a substituent, examples of the substituent include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group and a phosphoryl group. The substituent is preferably an alkyl group or an aryl group and examples thereof include a methyl group, an ethyl group, an isopropyl group, a tert-butyl group, a tert-octyl group, a phenyl group, a 4-alkoxyphenyl group and a 4-acyloxyphenyl group.

Specific examples of the alkyl group represented by R²¹ to R²³ include a methyl group, an ethyl group, a butyl group, an octyl group, a dodecyl group, an isopropyl group, a tert-butyl group, a tert-amyl group, a tert-octyl group, a cyclohexyl group, a 1-methylcyclohexyl group, a benzyl group, a phenethyl group and a 2-phenoxypropyl group.

Examples of the aryl group include a phenyl group, a cresyl group, a xylyl group, a naphthyl group, a 4-tert-butylphenyl group, a 4-tert-octylphenyl group, a 4-anisidyl group and a 3,5-dichlorophenyl group.

Examples of the alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group and a benzyloxy group.

Examples of the aryloxy group include a phenoxy group, a cresyloxy group, an isopropylphenoxy group, a 4-tert-butylphenoxy group, a naphthoxy group and a biphenyloxy group.

Examples of the amino group include a dimethylamino group, a diethylamino group, a dibutylamino group, a dioctylamino group, an N-methyl-N-hexylamino group, a dicyclohexylamino group, a diphenylamino group and an N-methyl-N-phenylamino group.

R²¹ to R²³ each is preferably an alkyl group, an aryl group, an alkoxy group or an aryloxy group. In view of the effect of the present invention, at least one of R²¹ to R²³ is preferably an alkyl group or an aryl group and more preferably, two or more thereof are an alkyl group or an aryl group. In view of the availability at a low cost, R²¹ to R²³ all are the same group.

Specific examples of the hydrogen bond-forming compound including the compound represented by formula (II) for use in the present invention are set forth below, however, the present invention is not limited thereto.

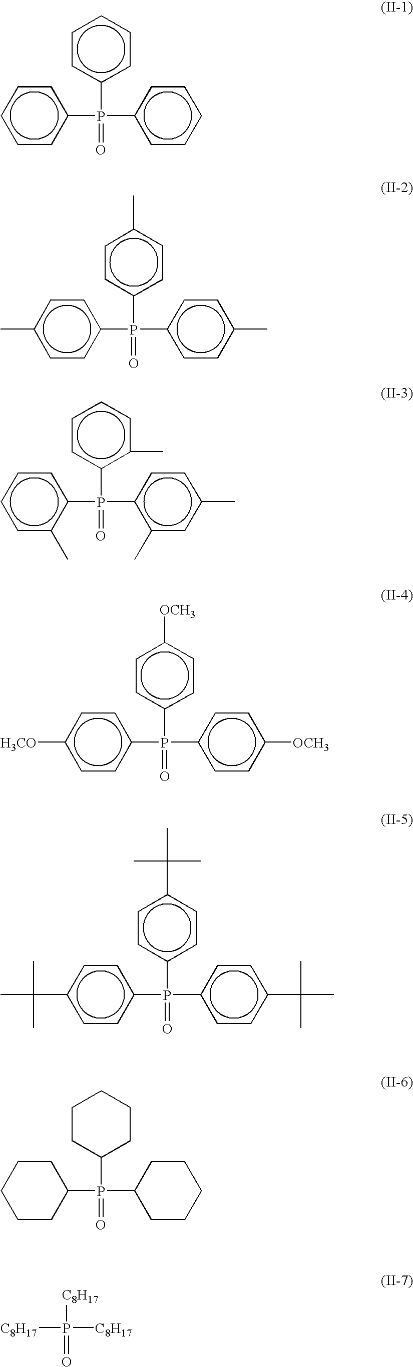

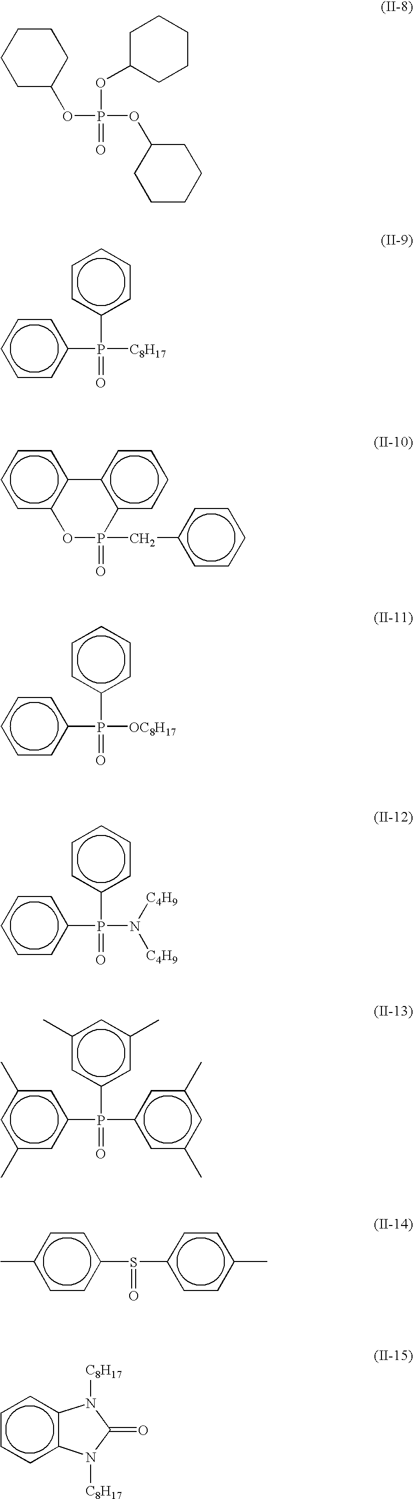

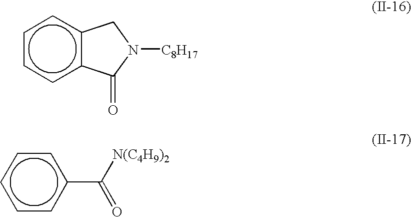

In addition to these compounds, specific examples of the hydrogen bond-forming compound include those described in Japanese Patent Application Nos. 2000-192191 and 2000-194811.

The compound represented by formula (II) for use in the present invention is incorporated into a coating solution and used in the photosensitive material, similarly to the reducing agent, in the form of a solutions an emulsified dispersion or a solid fine grain dispersion. In the solution state, this compound forms a hydrogen bond-forming complex with a compound having a phenolic hydroxyl group or an amino group and depending on the combination of the reducing agent and the compound represented by formula (II), the complex can be isolated in the crystal state. Use of the thus-isolated crystal powder as a solid fine grain dispersion is particularly preferred for attaining stable performance. Furthermore, a method of mixing the reducing agent and the compound represented by formula (II) each in the powder form and forming a complex at the dispersion in a sand grinder mill or the like using an appropriate dispersion is also preferably used.

The compound represented by formula (II) is preferably used in the range from 1 to 200 mol %, more preferably from 10 to 150 mol %, still more preferably from 30 to 100 mol %, based on the reducing agent.

The halogen composition of the photosensitive silver halide for use in the present invention is not particularly limited and silver chloride, silver chlorobromide, silver bromide, silver iodobromide and silver iodochlorobromide can be used. Among these, silver bromide and silver iodobromide are preferred. The halogen composition distribution within the grain may be uniform or the halogen composition may be stepwise or continuously changed. A silver halide grain having a core/shell structure may also be preferably used. With respect to the structure, the core/shell grain preferably has from 2 to 5-ply structure, more preferably from 2 to 4-ply structure. Furthermore, a technique of localizing silver bromide on the surface of a silver chloride or silver chlorobromide grain may also be preferably used.

The method of forming photosensitive silver halide is well known in the art and, for example, the methods described in Research Disclosure, No. 17029 (June, 1978) and U.S. Pat. No. 3,700,458 may be used. Specifically, a method of adding a silver-supplying compound and a halogen-supplying compound to gelatin or other polymer solution to prepare photosensitive silver halide and mixing the silver halide with an organic silver salt is used. In addition, the methods described in JP-A-11-119374 (paragraph Nos. 0217 to 0224) and Japanese Patent Application Nos. 11-98708 and 2000-42336 are also preferably used.

The photosensitive silver halide preferably has a small grain size so as to reduce the white turbidness after formation of an image. Specifically, the grain size is preferably 0.20 μm or less, more preferably from 0.01 to 0.15 μm, still more preferably from 0.02 to 0.12 μm. The term “grain size” as used herein means the diameter when the projected area (in the case of tabular grains, the projected area of main plane), of a silver halide grain is converted into a circular image having the same area.

Examples of the shape of silver halide grain include cubic form, octahedral form, tabular form, spherical form, bar form and bebble form and among these, cubic grain is particularly preferred in the present invention. A silver halide grain having rounded corners is also preferably used. The face index (Miller indices) of the outer surface plane of a photosensitive silver halide grain is not particularly limited, however, {100} faces capable of giving a high spectral sensitization efficiency upon adsorption of a spectral sensitizing dye preferably occupy a high percentage. The percentage is preferably 50% or more, more preferably 65% or more, still more preferably 80% or more. The percentage of {100} faces according to the Miller indices can be determined by the method described in T. Tani, J. Imaging Sci., 29, 165 (1985) using the adsorption dependency of {111} face and {100} face when a sensitizing dye is adsorbed.

In the present invention, a silver halide grain where a hexacyano metal complex is allowed to present on the outermost surface of the grain is preferred. Examples of the hexacyano metal complex include [Fe(CN₆)]⁴⁻, [Fe(CN₆)]³⁻, [Ru(CN₆)]⁴⁻, [Os(CN₆)]⁴⁻, [Co(CN₆)]³⁻, [Rh(CN₆)]³⁻, [Ir(CN₆)]³⁻. [Cr(CN₆)]³⁻ and [Re(CN₆)]³⁻. In the present invention, hexacyano Fe complexes are preferred.

The hexacyano metal complex is present in the form of ion in an aqueous solution and therefore, the counter cation is not important but a cation easily miscible with water and suitable for the precipitation operation of a silver halide emulsion is preferred. Examples thereof include alkali metal ions such as sodium ion, potassium ion, rubidium ion, cesium ion and lithium ion, ammonium ions, and alkylammonium ions (e.g., tetramethylammonium ion, tetraethylammonium ion, tetrapropylammonium ion, tetra(n-butyl)ammonium ion).

The hexacyano metal complex may be added after mixing it with water, a mixed solvent of water and an appropriate organic solvent miscible with water (for example, alcohols, ethers, glycols, ketones, esters and amides), or gelatin.

The amount of the hexacyano metal complex added is preferably from 1×10⁻⁵ to 1×10⁻² mol, more preferably from 1×10⁻⁴ to 1×10⁻³ mol, per mol of silver.

For allowing the hexacyano metal complex to be present on the outermost surface of a silver halide grain, the hexacyano metal complex is directly added after the addition of an aqueous silver nitrate solution used for the grain formation is completed but before starting the chemical sensitization step of performing chalcogen a sensitization such as sulfur sensitization, selenium sensitization and tellurium sensitization or noble metal sensitization such as gold sensitization, for example, before the completion of charging step, during the water washing step, during the dispersion step, or before the chemical sensitization step. In order to prevent growing of silver halide fine grains, the hexacyano metal complex is preferably added without delay after the grain formation but before the completion of charging step.

The addition of hexacyano metal complex may be started after silver nitrate which is added for the grain formation is added to consume 96% by mass of the total amount but is preferably started after 98% by mass, more preferably 99% by mass, of the total amount is added.

The hexacyano metal complex added after an aqueous silver nitrate solution is added immediately before the completion of grain formation can adsorb to the outermost surface of a silver halide grain and most of the complexes adsorbed form a sparingly-soluble salt with silver ion on the grain surface. This silver salt of hexacyano ferrate (II) is a salt more sparingly soluble than AgI and therefore, the fine grains can be prevented from re-dissolving, whereby silver halide fine grains having a small grain size can be produced.

The photosensitive silver halide grain for use in the present invention contains a metal or a metal complex of Group 8 to Group 10 in the Periodic Table (showing Group 1 to Group 18). The center metal of the metal or metal complex of Group 8 to Group 10 of the Periodic Table is preferably rhodium, ruthenium or iridium. One metal complex may be used or two or more complexes of the same metal or different metals may also be used in combination. The metal complex content is preferably from 1×10⁻⁹ to 1×10⁻³ mol per mol of silver. These metals and metal complexes and the addition methods therefor are described in JP-A-7-225449, JP-A-11-65021 (paragraph Nos. 0018 to 0024) and JP-A-11-119374 (paragraph Nos. 0227 to 0240).

Furthermore, metal atoms (for example, [Fe(CN)₆]⁴⁻) which can be contained in the silver halide grain for use in the present invention, and the methods for desalting and chemical sensitization of silver halide emulsion are described in JP-A-11-84574 (paragraph Nos. 0046 to 0050), JP-A-11-65021 (paragraph Nos. 0025 to 0031) and JP-A-11-119374 (paragraph Nos. 0242 to 0250).

As for the gelatin contained in the photosensitive silver halide emulsion for use in the present invention, various gelatins can be used. In order to maintain good dispersion state of the photosensitive silver halide emulsion in the organic silver salt-containing coating solution, a low molecular weight gelatin having a molecular weight of 500 to 60,000 is preferably used. This low molecular weight gelatin may be used during either the grain formation or the dispersion operation after the desalting but is preferably used during the dispersion operation after desalting.

As for the sensitizing dye which can be applied to the present invention, a sensitizing dye capable of spectrally sensitizing a silver halide grain in the desired wavelength region upon adsorption to the silver halide grain and having a spectral sensitivity suitable for the spectral characteristics of the light source for exposure can be advantageously selected. Examples of the sensitizing dye and the addition method therefor include those described in JP-A-11-65021 (paragraph Nos. 0103 to 0109), compounds represented by formula (II) of JP-A-10-186572, dyes represented by formula (X) of JP-A-11-119374 (including compounds of paragraph No. 0106), dyes described in U.S. Pat. Nos. 5,510,236 and 3,871,887 (Example 5), dyes disclosed in JP-A-2-96131 and JP-A-59-48753, and those described in EP-A-0803764 (page 19, line 38 to page 20, line 35) and Japanese Patent Application Nos. 2000-86865, 2000-102560 and 2000-205399. These sensitizing dyes may be used individually or in combination of two or more thereof. In the present invention, the timing of adding a sensitizing dye to a silver halide emulsion is preferably in the time period after the desalting step until the coating, more preferably in the time period after desalting until the starting of chemical ripening.

In the present invention, the desired amount of the sensitizing dye added may be selected according to the performance such as sensitivity or fogging, but the amount added is preferably from 10⁻⁶ to 1 mol, more preferably from 10⁻⁴ to 10⁻¹ mol per mol of silver halide in the photosensitive layer.

In the present invention, a supersensitizer may be used for elevating the spectral sensitization efficiency. Examples of the supersensitizer for use in the present invention include the compounds described in EP-A-587338, U.S. Pat. Nos. 3,877,943 and 4,873,184, JP-A-5-341432, JP-A-11-109547 and JP-A-10-111543.

In the present invention, the photosensitive silver halide grain is preferably subjected to chemical sensitization by sulfur sensitization, selenium sensitization or tellurium sensitization. As for the compounds preferably used in the sulfur sensitization, selenium sensitization and tellurium sensitization, known compounds, for example, compounds described in JP-A-7-128768 can be used. In the present invention, tellurium sensitization is preferred and the compounds described in JP-A-11-65021 (paragraph No. 0030) and the compounds represented by formulae (II), (III) and (IV) of JP-A-5-313284 are more preferred.

In the present invention the chemical sensitization may be performed at any stage if it is after the grain formation but before the coating. Examples of the timing of performing the chemical sensitization include, after desalting, (1) before spectral sensitization, (2) simultaneously with spectral sensitization, (3) after spectral sensitization and (4) immediately before coating. Particularly, the chemical sensitization preferably performed after the spectral sensitization.

The use amount of sulfur, selenium or tellurium sensitizer for use in the present invention varies depending on the silver halide grain used, chemical ripening conditions and the like, but these sensitizers each is preferably used in an amount of 10⁻⁸ to 10⁻² mol, preferably on the order of 10⁻⁷ to 10⁻³ mol, per mol of silver halide. In the present invention, the conditions for the chemical sensitization are not particularly limited but the pH is from 5 to 8, the pAg is from 6 to 11 and the temperature is on the order from 40 to 95° C.

In the silver halide emulsion for use in the present invention, a thiosulfonic acid compound may be added by the method described in EP-A-293917.

In the photosensitive material for use in the present invention, only one kind of photosensitive silver halide emulsion may be used or two or more kinds of emulsions (for example, emulsions different in the average grain size, in the halogen composition, in the crystal habit or in the chemical sensitization conditions) may be used in combination. By using a plurality of photosensitive silver halide different in the sensitivity, the gradation can be controlled. Examples of the technique related to these include JP-A-57-119341, JP-A-53-106125, JP-A-47-3929, JP-A-49-55730, JP-A-46-5187, JP-A-50-73627 and JP-A-57-150841. With respect to the difference in sensitivity, a difference of 0.21 ogE or more is preferably present between respective emulsions.

The amount of the photosensitive silver halide added is preferably, in terms of the coated silver amount per m² of the photosensitive-material, from 0.03 to 0.6 g/m², more preferably from 0.07 to 0.4 g/m², most preferably from 0.10 to 0.3 g/m². Also, the amount of the photosensitive silver halide added is preferably from 0.01 to 0.5 mol, more preferably from 0.02 to 0.3 mol, per mol of the organic silver salt.

As for the method and conditions for mixing the photosensitive silver halide and the organic silver salt which are prepared individually, a method of mixing the silver halide grains and the organic silver salt each after the completion of preparation, in a ball mill, a sand mill, a colloid mill, a vibration mill, a homogenizer or the like, or a method of preparing organic silver salt while mixing photosensitive silver halide of which preparation is completed at the arbitrary timing during the preparation of organic silver salt, may be used, however, these are not particularly limited insofar as the effect of the present invention can be satisfactorily brought out. In the mixing, it is preferred for controlling the photographic properties to mix two or more organic silver salt water dispersions with two or more photosensitive silver salt water dispersions.

In the present invention, the timing of adding silver halide to a coating solution for photosensitive layer is from 180 minutes before the coating to immediately before the coating, preferably from 60 minutes to 10 seconds before the coating. The mixing method and the mixing conditions are not particularly limited insofar as the effect of the present invention can be satisfactorily brought cut. Specifically, a method of mixing silver halide with the solution in a tank designed to give a desired average residence time which is calculated from the addition flow rate and the liquid transfer amount to the coater, or a method using a static mixer described in N. Harnby, F. Edwards and A. W. Nienow (translated by Koji Takahashi), Ekitai Kongo Gijutsu (Liquid Mixing Technique), Chap. 8, Nikkan Kogyo Shinbun Sha (1989) may be used.

In the present invention the binder for the organic silver salt-containing layer may be any polymer and the suitable binder is transparent or translucent and generally colorless. Examples thereof include natural resin, polymer and copolymer; synthetic resin, polymer and copolymer; and other film-forming medium such as gelatins, rubbers, poly(vinyl alcohols), hydroxyethyl celluloses, cellulose acetates, cellulose acetate butyrates, polyvinyl pyrrolidones), casein, starch, poly(acrylic acids), poly(methyl methacrylates), polyvinyl chlorides), poly(methacrylic acids), styrene-maleic anhydride copolymers, styrene-acrylonitrile copolymers, styrene-butadiene copolymers, poly(vinyl acetals) (e.g., poly(vinyl formal), poly(vinyl butyral)), poly(esters), poly(urethanes), phenoxy resin, poly(vinylidene chlorides), poly(epoxides), poly (carbonates), poly(vinyl acetates), poly(olefins), cellulose esters and poly(amides). The binder may also be coated and formed from water, an organic solvent or an emulsion.

In the present invention, the glass transition temperature of the binder for the organic silver salt-containing layer is preferably from 10 to 80° C. (hereinafter sometimes called a “high Tg binder”), more preferably from 20 to 70° C., still more preferably from 23 to 65° C.

In the present specification, the Tg is calculated by the following formula:

1/Tg=Σ(Xi/Tgi)

wherein assuming that the polymer is resultant of the copolymerization of n monomer components from i=1 to i=n, Xi is the weight partial ratio (ΣXi=1) of the i-th monomer and Tgi is the glass transition temperature (absolute temperature) of a homopolymer of the i-th monomer, provided that Σ is the sum of i=1 to i=n. Incidentally, for the glass transition temperature (Tgi) of a homopolymer of each monomer, the values described in J. Brandrup and E. H. Immergut, Polymer Handbook, 3rd ed., Wiley-Interscience (1989) are employed.

The polymer as a binder may be a single kind of polymer or, if desired, two or more kinds of polymers may be used in combination. A polymer having a glass transition temperature of 20° C. or more and a polymer having a glass transition temperature of less than 20° C. may be used in combination. In the case of using a blend of two or more kinds of polymers different in the Tg, the weight average Tg thereof is preferably within the above-described range.

In the present invention, the performance is enhanced when the organic silver salt-containing layer is formed by coating and drying a coating solution with 30 wt % or more of the solvent being water, furthermore when the binder of the organic silver salt-containing layer is soluble or dispersible in an aqueous solvent (water solvent), particularly when the binder is composed of a polymer latex having an equilibrium moisture content at 25° C. and 60% RH of 2% by mass or less. In a most preferred form, the binder is prepared to have an ion conductivity of 2.5 mS/cm or less. Examples of this preparation method include a method of synthesizing a polymer and then purifying it using a membrane having a separating function.

The term “an aqueous solvent where the above-described polymer is soluble or dispersible” as used herein means water or a mixture of water and 70% by mass or less of a water-miscible organic solvent. Examples of the water-miscible organic solvent include alcohol-base solvents such as methyl alcohol, ethyl alcohol and propyl alcohol, cellosolve-base solvents such as methyl cellosolve, ethyl cellosolve and butyl cellosolve, ethyl acetate, and dimethylformamide.

The term “aqueous solvent” is used here even for a system where the polymer is not thermodynamically dissolved but is present in the so-called dispersed state.

The “equilibrium moisture content at 25° C. and 60% RH” can be expressed as follows using the weight W1 of a polymer in the humidity equilibration in an atmosphere of 25° C. and 60% RH and the weight W0 of a polymer in the bone dry state at 25° C.:

Equilibrium moisture content at 25° C. and 60% RH={(W1−W0)/W0}×100(% by mass)

With respect to the definition and the measuring method of moisture content, for example, Kobunshi Kogaku Koza 14, Kobunshi Zairyo Shiken Hou (Lecture 14 of Polymer Engineering, Polymer Material Testing Method), compiled by Kobunshi Gakkai, Chijin Shokan, may be referred to.

In the present invention, the equilibrium moisture content at 25° C. and 60% RH of the binder polymer is preferably 2% by mass or less, more preferably from 0.01 to 1.5% by mass, still more preferably from 0.02 to 1% by mass.

In the present invention, a polymer dispersible in an aqueous solvent is particularly preferred. Examples of the dispersed state include a case where fine grains of a water-insoluble hydrophobic polymer are dispersed in a latex, and a case where polymer molecules are dispersed in the molecular state or by forming micelles. Either case is preferred. The average particle size of the dispersed particles is preferably from 1 to 50,000 nm, more preferably on the order of 5 to 1,000 nm. The particle size distribution of the dispersed particles is not particularly limited and the dispersed particles may have either a wide particle size distribution or a monodisperse particle size distribution.

In the present invention, in a preferred embodiment of the polymer dispersible in an aqueous solvent, hydrophobic polymers such as acrylic resin, poly(esters), rubbers (e.g., SBR resin), poly(urethanes), poly(vinyl chlorides), poly(vinyl acetates), poly(vinylidene chlorides) and poly(olefin), may be preferably used. This polymer may be a linear polymer, a branched polymer or a crosslinked polymer and also may be a homopolymer obtained by polymerizing a single monomer or a copolymer obtained by polymerizing two ox more kinds of monomers. In the case of a copolymer, the copolymer may be a random copolymer or a block copolymer. The molecular weight of this polymer is, in terms of the number average molecular weight, from 5,000 to 1,000,000, preferably from 10,000 to 200,000. If the molecular weight is too small, the formed emulsion layer is insufficient in the mechanical strength, whereas if the molecular weight is excessively large, the film forming property is poor and this is not preferred.

Specific examples of preferred polymer latexes include the followings. In the following, the polymer latex is expressed using the starting material monomers. The numerical value in the parenthesis is in the unit of % by mass and the molecular weight is a number average molecular weight. In the case of using a polyfunctional monomer, a cross-linked structure is formed and the concept of molecular weight cannot be applied, therefore, the term “crosslinkable” is shown and the molecular weight is not described. “Tg” means a “glass transition temperature”.

| | |
|---|---|
| P-1: | latex of -MMA(70)-EA(27)-MAA(3)- (molecular weight: |
| | 37,000) |
| P-2: | latex of -MMA(70)-2EHA(20)-St(5)--AA(5)- (molecular |
| | weight: 40,000) |
| P-3: | latex of -St(50)-Bu(47)-MAA(3)- (crosslinkable) |
| P-4: | latex of -St(68)-Bu(29)-AA(3)- (crosslinkable) |
| P-5: | latex of -St(71)-Bu(26)-AA(3)- (crosslinkable, Tg: |
| | 24° C.) |
| P-6: | latex of -St(70)-Bu(27)-IA(3)- (crosslinkable) |
| P-7: | latex of -St(75)-Bu(24)-AA(1)- (crosslinkable) |
| P-9: | latex of -St(60)-Bu(35)-DVB(3)-MAA(2)- |
| | (crosslinkable) |
| P-9: | latex of -St(70)-Bu(25)-DVB(2)-AA(3)- (crosslinkable) |
| P-10: | latex of -VC(50)-MMA(20)-EA(20)-AN(5)-AA(5)- |
| | (molecular weight: 80,000) |
| P-11: | latex of -VDC(85)-MMA(5)-EA(5)-MAA(5)- (molecular |
| | weight: 67,000) |
| P-12: | latex of -Et(90)-MMA(10)- (molecular weight: 12,000) |
| P-13: | latex of -St(70)-2EHA(27)-AA(3) (molecular weight: |
| | 130,000) |
| P-14: | latex of -MAA(63)-EA(35)-AA(2) (molecular weight: |
| | 33,000) |
| P-15: | latex of -St(70.5)-Bu(26.5)-AA43)- (crosslinkable, |
| | Tg: 23° C.) |
| P-16: | latex of -St(69.5)-Bu(27.5)-AA(3)- (crosslinkable, |
| | Tg: 20.5° C. |

In the above-described structures, the abbreviations indicate the following monomers: MMA: methyl methacrylate, EA: ethyl acrylate, MAA: methacrylic acid, 2EHA: 2-ethylhexyl acrylate, St: styrene, Bu: butadiene, AA: acrylic acid, DVB: divinylbenzene, VC: vinyl chloride, AN: acrylonitrile, VDC: vinylidene chloride, Et: ethylene, and IA: itaconic acid.

These polymer latexes are also commercially available and the following polymers may be used. Examples of the acrylic polymer include Sebian A-4635, 4718, 4601 (all produced by Daicel Chemical Industries, Ltd.), Nipol Lx811, 814, 821, 820 and 857 (all produced by Nippon Zeon K.K.); examples of poly(esters) include FINETEX ES650, 611, 675, 850 (all produced by Dai-Nippon Ink & Chemicals, Inc.), WD-size and WMS (all produced by Eastman Chemical Products, Inc.); examples of poly(urethanes) include HYDRAN AP10, 20, 30, 40 (all produced by Dai-Nippon Ink & Chemicals, Inc.); examples of rubbers include LACSTAR 7310K, 3307B, 4700H, 7132C (all produced by Dai-Nippon Ink & Chemicals, Inc.), Nipol Lx416, 410, 438C and 2507 (all produced by Nippon Zeon K.K.); examples of poly(vinyl chlorides) include G351 and G576 (both produced by Nippon Zeon K.K.); examples of poly(vinylidene chlorides) include L502 and L513 (both produced by Asahi Chemical Industry Co., Ltd.); and examples of poly(olefins) include Chemipearl S120 and SA100 (both produced by Mitsui Petrochemical Industries, Ltd.).

These polymer latexes may be used individually or, if desired, two or more thereof may be blended.

The polymer latex for use in the present invention is particularly preferably a latex of styrene-butadiene copolymer. In the styrene-butadiene copolymer, the weight ratio between the styrene monomer unit and the butadiene monomer unit is preferably from 40:60 to 95:5. Furthermore, the styrene monomer unit and the butadiene monomer unit preferably occupy from 60 to 99 wt % in the copolymer. The preferred molecular weight range is the same as above.

Examples of the styrene-butadiene copolymer latex which is preferably used in the present invention include P-3 to P-8, P-14 and P-15 described above and commercially available products LACSTAR-3307B, 7132C and Nipol Lx416.

The organic silver salt-containing layer of the heat-developable photosensitive material of the present invention may contain, if desired, a hydrophilic polymer such as gelatin, polyvinyl alcohol, methyl cellulose and hydroxypropyl cellulose. The amount of the hydrophilic polymer added is preferably 30% by mass or less, more preferably 20% by mass or less, based on the entire binder.

In the present invention, the organic silver salt-containing layer (namely, image-forming layer) is preferably formed using a polymer latex and the amount of the binder in the organic silver salt-containing layer is preferably, in terms of the weight ratio of the entire binder/organic silver salt, from 1/10 to 10/1, more preferably from 1/5 to 4/1.

This organic silver salt-containing layer usually works out also to a photosensitive layer (emulsion layer) containing a photosensitive silver halide which is a photosensitive silver salt. In this case, the weight ratio of the entire binder/silver halide is preferably from 400 to 5, more preferably from 200 to 10.

In the present invention, the total binder amount of the image-forming layer is preferably from 0.2 to 30 g/m², more preferably from 1 to 15 g/m². The image-forming layer for use in the present invention may contain a crosslinking agent for forming a crosslinked structure or a surfactant for improving the coatability.

In the present invention, the solvent used in the coating solution for the organic silver salt-containing layer of the heat-developable photosensitive material (for the sake of simplicity, the solvent and the dispersion medium are collectively called a solvent here) is preferably an aqueous solvent containing 30 wt % or more aof water. As for the component other than water, an optional water-miscible organic solvent may be used, such as methyl alcohol, ethyl alcohol, isopropyl alcohol, methyl cellosolve, ethyl cellosolve, dimethylformamide and ethyl acetate. The solvent of the coating solution preferably has a water content of 50% by mass or more, more preferably 70% by mass or more. Examples of preferred solvent compositions include, in addition to water, water/methyl alcohol=90/10, water/methyl alcohol=70/30, water/methyl alcohol/dimethyl-formamide=80/15/5, water/methyl alcohol/ethyl cellosolve=85/10/5 and water/methyl alcohol/isopropyl alcohol=85/10/5 (the numerals are % by mass).

Examples of the antifoggant, the stabilizer and the stabilizer precursor which can be used in the present invention include those described in JP-A-10-62899 (paragraph No. 0070) and EP-A-0803764 (page 20, line 57 to page 21, line 7), and compounds described in JP-A-9-281637 and JP-A-9-329264. The antifoggant preferably used in the present invention is an organic halide and examples thereof include those disclosed in the patents described in JP-A-11-65021 (paragraph Nos. 0111 to 0112) In particular, organic halogen compounds represented by formula (P) of Japanese Patent Application No. 11-87297, organic polyhalogen compounds represented by formula (II) of JP-A-10-339934, and organic polyhalogen compounds described in Japanese Patent Application No. 11-205330 are preferred.

The organic polyhalogen compound which is preferably used in the present invention is described specifically below. The polyhalogen compound preferred in the present invention is a compound represented by the following formula (III):

Q-(Y)ₙ-C(Z₁)(Z₂)X

wherein Q represents an alkyl group, an aryl group or a heterocyclic group, Y represents a divalent linking group, n represents 0 or 1, Z₁ and Z₂ each represents a halogen atom and X represents a hydrogen atom or an electron-withdrawing group.

In formula (III), Q preferably represents a phenyl group substituted by an electron-withdrawing group having a Hammette's substituent constant σp of a positive value. The Hammette's substituent constant is described, for example, in Journal of Medicinal chemistry, Vol. 16, No. 11, 1207-1216 (1973). Examples of this electron-withdrawing group include halogen atoms (e.g., fluorine (σp value: 0.06), chlorine (σp value; 0.23), bromine (σp value: 0.23), iodine (σp value; 0.18)), trihalomethyl groups (e.g., tribromo-methyl (σp value: 0.29), trichloromethyl (σp value: 0.33), trifluoromethyl (σp value: 0.54)), a cyano group (σp value: 0.66), a nitro group (σp value: 0.78), aliphatic aryl or heterocyclic sulfonyl groups (e.g., methanesulfonyl (σp value: 0.72)), aliphatic aryl or heterocyclic acyl groups (e.g., acetyl (σp value: 0.50), benzoyl (σp value: 0.43)), alkynyl groups (e.g., C≡CH (σp value: 0.23)), aliphatic aryl or heterocyclic oxycarbonyl groups (e.g., methoxy-carbonyl (σp value; 0.45), phenoxycarbonyl (σp value: 0.44)), a carbamoyl group (σp value: 0.36) and a sulfamoyl group (σp value; 0.57). The σp value is preferably from 0.2 to 2.0, more preferably from 0.4 to 1.0. Preferred examples of the electron-withdrawing group include a carbamoyl group, an alkoxycarbonyl group, an alkylsulfonyl group and an alkylphosphoryl group. Among these, a carbamoyl group is most preferred.

X is preferably an electron-withdrawing group, preferably a halogen atom, an aliphatic aryl or heterocyclic sulfonyl group, an aliphatic aryl or heterocyclic acyl group, an aliphatic aryl or heterocyclic oxycarbonyl group, a carbamoyl group or a sulfamoyl group, more preferably a halogen atom. Among halogen atoms, a chlorine atom, a bromine atom and an iodine atom are preferred, a chlorine atom and a bromine atom are more preferred, and a bromine atom is particularly preferred.

Y preferably represents —C(═O)—, —SO— or —SO₂—, more preferably —C(═O)— or —SO₂—, still more preferably —SO₂—. n represents 0 or 1, preferably 1.

Specific examples of the compound represented by formula (III) for use in the present invention are set forth below, however, the present invention is not limited to these specific examples.

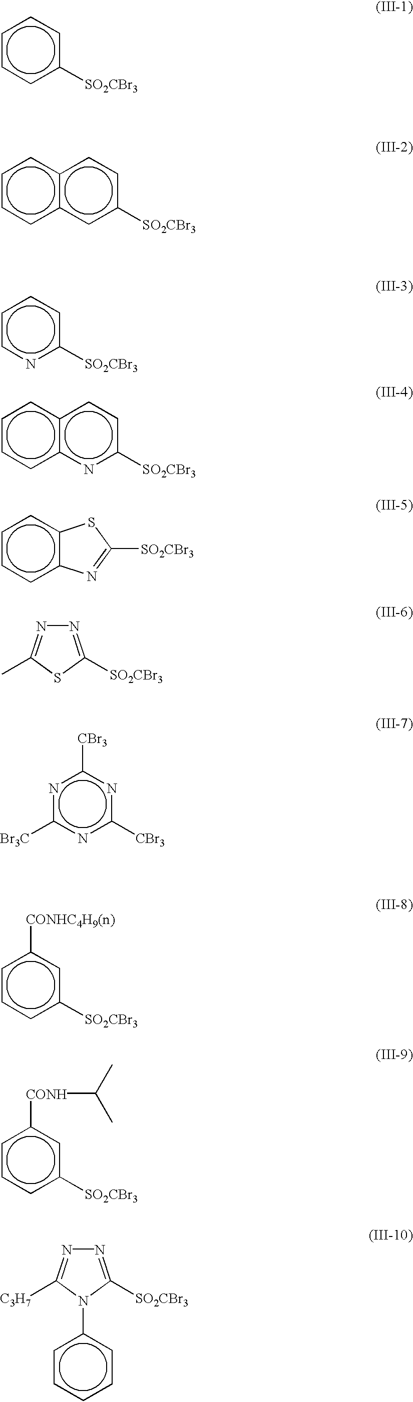

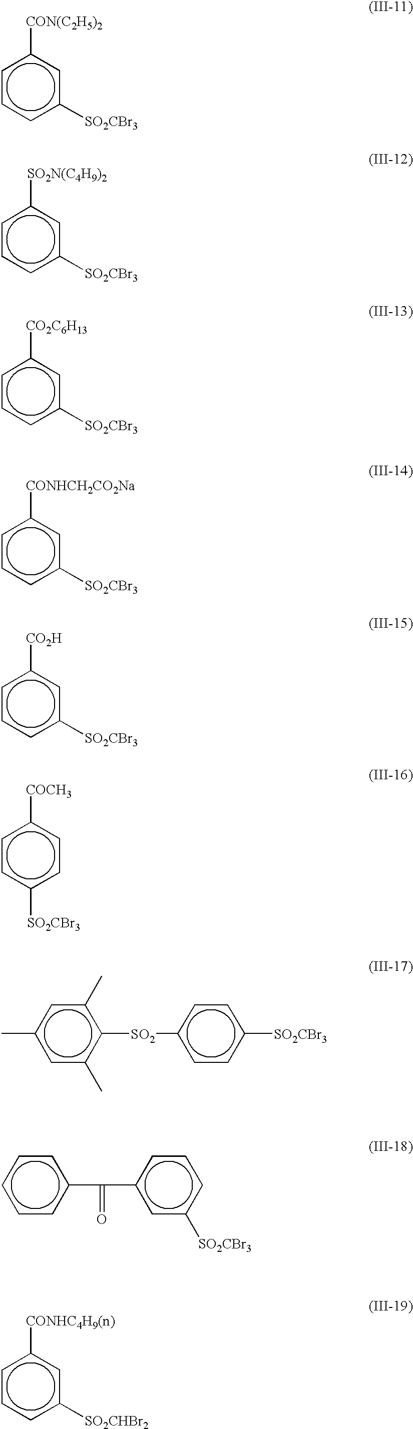

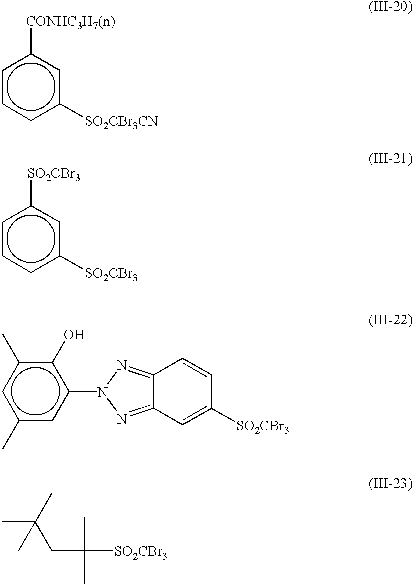

In the present invention, the compound represented by formula (III) is preferably used in the range from 10⁻⁴ to 1 mol, more preferably from 10⁻³ to 0.8 mol, still more preferably from 5×10⁻³ to 0.5 mol, per mol of the non-photosensitive organic silver salt in the image-forming layer.

In the present invention, for incorporating an antifoggant into the photosensitive material, those methods described above with respect to the method for incorporating a reducing agent may be used. The organic polyhalogen compound is also preferably added in the form of a solid fine particle dispersion.

Other examples of the antifoggant include mercury(II) salts described in JP-A-11-65021 (paragraph No. 0113), benzoic acids described in the same patent publication (paragraph No. 0114), salicylic acid derivatives described in JP-A-2000-206642, formalin scavenger compounds represented by formula (S) of JP-A-2000-221634, triazine compounds according to claim 9 of JP-A-11-352624, compounds represented by formula (III) of JP-A-6-11791, and 4-hydroxy-6-methyl-1,3,3a,7-tetrazaindene.

For the purpose of preventing fogging, the heat-developable photosensitive material of the present invention may contain an azolium salt. Examples of the azolium salt include the compounds represented by formula (XI) of JP-A-59-193447, the compounds described in JP-B-55-12581, and the compounds represented by formula (II) of JP-A-60-153039. The azolium salt may be added to any site of the photosensitive material but is preferably added to a layer on the surface having a photosensitive layer, more preferably to an organic silver salt-containing layer. The timing of adding azolium salt may be any step during the preparation of the coating solution. In the case of adding the azolium salt to the organic silver salt-containing layer, the addition may be made in any step between the preparation of the organic silver salt and the preparation of the coating solution, however, the addition is preferably made between after the preparation of the organic silver salt and immediately before the coating. The azolium salt ray be added by any method such as powder, solution or fine grain dispersion and may also be added as a mixture solution with other additives such as sensitizing dye, reducing dye and toning agent. In the present invention, the azolium salt may be added in any amount but the amount added is preferably from 1×10⁻⁶ to 2 mol, more preferably from 1×10⁻³ to 0.5 mol, per mol of silver.

In the present invention, a mercapto compound, a disulfide compound or a thione compound may be incorporated so as to enhance the spectral sensitization efficiency or improve the storability before or after the development. Examples of these compounds include the compounds described in JP-A-10-62899 (paragraph Nos. 0067 to 0069), the compounds represented by formula (I) of JP-A-10-186572 (and specific examples thereof described in paragraph Nos. 0033 to 0052) and the compounds described in EP-A-0803764 (page 20, lines 36 to 56) and Japanese Patent Application No. 11-273670. Among these, mercapto-substituted heteroaromatic compounds are preferred.

In the present invention, a color toning agent is preferably added to the heat-developable photosensitive material. Examples of the color toning agent include those described in JP-A-10-62899 (paragraph Nos. 0054 to 0055), EP-A-0803764 (page 21, lines 23 to 48), JP-A-2000-356317 and Japanese Patent Application No-2000-187298. Among these, preferred are phthalazinones (phthalazinone, phthalazinone derivatives, and metal salts of phthalazinone, e.g., 4-(1-naphthyl)phthalazinone, 6-chlorophthalazinone, 5,7-dimethoxyphthalazinone, 2,3-dihydro-1,4-phthalazine-dione); combinations of a phthalazinone and a phthalic acid (e.g., phthalic acid, 4-methylphthalic acid, 4-nitrophthalic acid, diammonium phthalate, sodium phthalate, potassium phthalate, tetrachlorophthalic anhydride); phthalazines (phthalazine, phthalazine derivatives, and metal salts of phthalazine, e.g., 4-(1-naphthyl)phthalazine, 6-isopropylphthalazine, 6-tert-butylphthalazine, 6-chlorophthalazine, 5,7-dimethoxyphthalazine, 2,3-dihydrophthalazine); and combinations of a phthalazine and a phthalic acid, with the combinations of a phthalazine and a phthalic acid being more preferred.

Examples of the plasticizer and lubricant which can be used in the photosensitive material in the present invention include those described in JP-A-11-65021 (paragraph No. 0117); examples of the ultrahigh contrast-providing agent for the formation of an ultrahigh contrast image and the method for the addition or the amount thereof include those described in JP-A-11-65021 supra (paragraph No. 0118), JP-A-11-223898 (paragraph Nos. 0136 to 0193), compounds represented by formula (H), formulae (1) to (3) and formulae (A) and (13) of Japanese Patent Application No. 11-87297, and compounds represented by formulae (III) to (V) (specific compounds: Chem. 21 to Chem. 24) of Japanese Patent Application No. 11-91652; and examples of the contrast-promoting agent include those described in JP-A-11-654021 (paragraph No. 0102) and JP-A-11-223898 (paragraph Nos. 0194 to 0195).

For using a formic acid or a formate as a strong foggant, this is preferably contained in the side having an image forming layer containing a photosensitive silver halide, in an amount of 5 mmol or less, more preferably 1 mol or less, per mol of silver.

In the case where an ultrahigh contrast-providing agent is used in the heat-developable photosensitive material of the present invention, an acid resulting from the hydration of diphosphorus pentoxide, or a salt thereof is preferably used in combination. Examples of the acid resulting from the hydration of diphosphorus pentoxide, and salts thereof include metaphosphoric acid (and salts thereof), pyrophosphoric acid (and salts thereof), orthophosphoric acid (and salts thereof), triphosphoric acid (and salts thereof), tetraphosphoric acid (and salts thereof), and hexametaphosphoric acid (and salts thereof). Among these, preferred are orthophosphoric acid (and salts thereof) and hexametaphosphoric acid (and salts thereof). Specific examples of the salt of the acid resulting from the hydration of disphosphorus pentoxide include sodium orthophosphate, sodium dihydrogen orthophosphate, sodium hexametaphosphate and ammonium hexametaphosphate.

The amount added (coverage per m² of the photosensitive element) of the acid resulting from the hydration of disphosphorus pentoxide, or a salt thereof may be appropriately selected in accordance with the properties such as sensitivity and fog, but the amount added is preferably from 0.1 to 500 mg/m², more preferably 0.5 to 100 mg/m².

In the heat-developable photosensitive material of the present invention, a surface protective layer may be provided for the purpose of preventing the adhesion of image-forming layer. The surface protective layer may consist of a single layer or a plurality of layers. As for the surface protective layer, JP-A-11-65021 (paragraph Nos. 0119 to 0120) and Japanese Patent Application No. 2000-171936 describe this.

In the present invention, the binder for the surface protective layer is preferably gelatin but polyvinyl alcohol (PVA) may also be preferably used or may be preferably used in combination with gelatin. Examples of the gelatin which can be used include inert gelatin (e.g., Nitta gelatin 750) and phthalated gelatin (e.g., Nitta gelatin 801). Examples of PVA include those described in JP-A-2000-171936 (paragraph Nos. 0009 to 0020) and preferred examples thereof include completely saponified product PVA-105, partially saponified product PVA-205 and PVA-335 and modified polyvinyl alcohol MP-203 (a trade name, produced by Kuraray Co., Ltd. The polyvinyl alcohol coverage (per m² of the support) of the protective layer (per one layer) is preferably from 0.3 to 4.0 g/m², more preferably from 0.3 to 2.0 g/m².

Particularly, in the case of using the heat-developable photosensitive material for printing where the dimensional change works out to a problem, a polymer latex is preferably used in the surface protective layer or the back layer. As for this polymer latex, Taira Okuda and Hiroshi Inagaki (compilers), Gosei Jushi Emulsion (Synthetic Resin Emulsion), Kobunshi Kankokai (1978), Takaaki Sugimura, Yasuo Kataoka, Soichi Suzuki and Keishi Kasahara (compilers), Gosei Latex no Oyo (Application of Synthetic Latex), Kobunshi Kankokai (1993), and Soichi Muroi, Gosei Latex no Kagaku (Chemistry of Synthetic Latex), Kobunshi Kankokai (1970) describe this. Specific examples of the polymer latex include a latex of methyl methacrylate (33.5% by mass)/ethyl acrylate (50% by maass)/methacrylic acid (16.5% by mass) copolymer, a latex of methyl methacrylate (47.5% by mass)/butadiene (47.5% by nmass)/itaconic acid (5% by mass) copolymer, a latex of ethyl acrylate/methacrylic acid copolymer, a latex of methyl methacrylate (58.9% by mass)/2-ethylhexyl acrylate (25.4% by mass)/styrene (8.6% by mass)/2-hydroxyethyl methacrylate (5.1% by mass)/acrylic acid (2.0% by mass) copolyimer and a latex of methyl methacrylate (64.0% by mass)/styrene (9.0% by mass)/butyl acrylate (20.0% by mass)/2-hydroxyethyl methacrylate (5.0% by mass)/acrylic acid (2.0% by mass) copolymer, For the hinder of the surface protective layer, a combination of polymer latexes described in Japanese Patent application No. 11-6872, and the techniques described in Japanese Patent Application Nos. 11-143058 (paragraph Nos. 0021 to 0025), 11-6872 (paragraph Nos. 0027 to 0028) and 10-199626 (paragraph Nos. 0023 to 0041) may also be applied. The percentage of the polymer latex in the surface protective layer is preferably from 10 to 90% by mass, more preferably from 20 to 80% by mass, based on the entire binder.

The coverage (per m² of the support) of the entire tinder (including water-soluble polymer and latex polymer) for the surface protective layer (per one layer) is preferably from 0.3 to 5.0 g/m², more preferably from 0.3 to 2.0 g/m².

In the present invention, the temperature at the preparation of a coating solution for the image-forming layer is preferably from 30 to 65° C., more preferably from 35 to less than 60° C., still more preferably from 35 to 55° C. Furthermore, the coating solution for the image-forming layer immediately after the addition of the polymer latex is preferably kept at a temperature of 30 to 65° C.

In the present invention, the image-forming layer is composed of one or more layer(s) on the support. In the case where the image-forming layer is composed of one layer, the layer comprises an organic silver salt, a photosensitive silver halide, a reducing agent and a binder and if desired, additionally contains desired materials such as a color toning agent, a coating aid and other adjuvants. In the case where the image-forming layer is composed of two or more layers, a first image-forming layer (usually a layer adjacent to the support) contains an organic silver salt and a photosensitive silver halide, and a second image-forming layer or these two layers contain some other components. In the structure of a multi-color photosensitive heat-developable photographic material, a combination of these two layers may be provided for each color or as described in U.S. Pat. No. 4,708,928, all components may be contained in a single layer. In the case of a multi-dye multicolor photosensitive heat-developable photographic material, respective emulsion layers are held, as described in U.S. Pat. No. 4,460,681, in the separated state from each other by using a functional or nonfunctional barrier layer.

In the present invention, the photosensitive layer may contain various dyes or pigments (for example, C.I. Pigment Blue 60, C.I. Pigment Blue 64, C.I. Pigment Blue 15:6) from the standpoint of improving the tone, inhibiting the generation of interference fringes on laser exposure or preventing the irradiation. These are described in detail in WO98/36322, JP-A-10-268465 and JP-A-11-338098.

In the heat-developable photosensitive material of the present invention, an antihalation layer can be provided in the side farther from the light source with respect to the photosensitive layer.

The heat-developable photosensitive material generally has a non-photosensitive layer in addition to the photosensitive layer. The non-photosensitive layer can be classified by the position disposed, into (1) a protective layer provided on a photosensitive layer (in the side farther from the support), (2) an interlayer provided between a plurality of photosensitive layers or between a photosensitive layer and a protective layer, (3) an undercoat layer provided between a photosensitive layer and a support, and (4) a back layer provided on the side opposite the photosensitive layer. In the photosensitive material, a filter layer is provided as the layer (1) or (2) and an antihalation layer is provided as the (3) or (4).

As for the antihalation layer, JP-A-11-65021 (paragraph Nos. 0123 to 0124), JP-A-11-223898, JP-A-9-230531, 7P-A-10-36695, JP-A-10-104779, JP-A-11-231457, JP-A-11-352625 and JP-A-11-352626.

The antihalation layer contains an antihalation dye having absorption in the exposure wavelength. In the case where the exposure wavelength is present in the infrared region, an infrared absorbing dye may be used and in this case, the dye preferably has no absorption in the visible region.

In the case of preventing the halation using a dye having absorption in the visible dye, it is preferred to allow substantially no color of the dye to remain after the formation of an image. For this purpose, means capable of decolorizing under the action of heat at the heat development is preferably used. In particular, the non-photosensitive layer is preferably rendered to function as an antihalation layer by adding thereto a thermally decolorizable dye and a base precursor. JP-A-11-231457 describes these techniques.

The amount of the decolorizable dye added is determined according to the use of the dye. In general, the decolorizable dye is used in an amount of giving an optical density (absorbency) in excess of 0.1 when measured at the objective wavelength. The optical density is preferably from 0.2 to 2. For obtaining such an optical density, the amount of the dye used is generally on the order from 0.001 to 1 g/m².

By decolorizing such a dye, the optical density can be reduced to 0.1 or less. Two or more decolorizable dyes may be used in combination in the thermally decolorizable recording material or heat-developable photosensitive material. Also, two or more base precursors may be used in combination.

In the thermal decolorization using these decolorizable dye and base precursor, a substance (e.g., diphenylsulfone, 4-chlorophenyl (phenyl) sulfone) capable of lowering the melting point by 3° C. or more when mixed with the base precursor, described in JP-A-11-352626, is preferably used in combination in view of the thermal decolorizability and the like.

In the present invention, a coloring agent having an absorption maximum at 300 to 450 nm can be added for the purpose of improving the silver tone or the aging change of image. Examples of such a coloring agent include those described in JP-A-62-210458, JP-A-63-104046, JP-A-63-103235, JP-A-63-208846, JP-A-63-306436, JP-A-63-314535, JP-A-01-61745 and Japanese Patent Application No. 11-276751.

This coloring agent is usually added in the range from 0.1 mg/m² to 1 g/m² and the layer to which the coloring agent is added is preferably a back layer provided in the side opposite the photosensitive layer.

The heat-developable photosensitive material of the present invention is preferably a so-called one-side photosensitive material having at least one photosensitive layer containing a silver halide emulsion on one side of the support and a back layer on the other side.

In the present invention, a matting agent is preferably added for improving the transportation property. Examples of the matting agent include those described in JP-A-11-65021 (paragraph Nos. 0126 to 0127). The amount of the matting agent added is, in terms of the coverage per m² of the photosensitive material, preferably from 1 to 400 mg/m², more preferably from 5 to 300 mg/m².

The matting degree on the emulsion surface may be any value insofar as a stardust failure does not occur, but is preferably, in terms of the Beck smoothness, from 30 to 2,000 seconds, more preferably from 40 to 1,500 seconds. The Beck smoothness can be easily determined according to Japanese Industrial Standard (JIS) P8119, “Test Method for Smoothness of Paper and Paperboard by Beck Tester” and TAPPI Standard Method T479.

As for the matting degree of the back layer for use in the present invention, the Beck smoothness is preferably from 10 to 1,200 seconds, more preferably from 20 to 800 seconds, still more preferably from 40 to 500 seconds.

In the present invention, the matting agent is preferably incorporated into the outermost surface layer, a layer acting as the outermost surface layer, or a layer close to the outer surface layer, or preferably incorporated into a layer acting as a protective layer.

As for the back layer which can be applied to the present invention, JP-A-11-65021 (paragraph Nos. 0128 to 0130) describes this.

In the heat-developable photosensitive layer, the pH on the layer surface before the heat development processing is preferably 7.0 or less, more preferably 6.6 or less. The lower limit thereof is not particularly limited but is about 3. The most preferred pH range is from 4 to 6.2. The pH on the layer surface can be adjusted using a nonvolatile acid such as organic acid (e.g., phthalic acid derivative) or sulfuric acid or a volatile base such as ammonia and this is preferred from the standpoint of reducing the pH on the layer surface. In particular, ammonia is readily volatilized and can be removed before the coating step or the heat development, and this is advantageous in achieving a low layer surface pH.

Furthermore, a combination use of ammonia with a nonvolatile base such as sodium hydroxide, potassium hydroxide or lithium hydroxide is preferably used. As for the method of measuring the layer surface pH, Japanese Patent Application No. 11-87297 (paragraph No. 0123) describes this.

The layers for use in the present invention such as a photosensitive layer, a protective layer and a back layer, each may use a hardening agent. Examples of the hardening agent include those described in T. H. James, The Theory of the Photographic Process Fourth Edition, pp. 77-87, Macmillan Publishing Co., Inc. (1977), chrome alum, 2,4-dichloro-6-hydroxy-s-triazine sodium salt, N,N-ethylene-bis(vinylsulfonacetamide) and N,N-propylenebis(vinylsulfonacetamide). Other than these, polyvalent metal ion described in ibid., page 78, polyisocyanates described in U.S. Pat. No. 4,281,060 and JP-A-6-208193, epoxy compounds described in U.S. Pat. No. 4,791,042, and vinyl sulfone-base compounds described in JP-A-62-89048 are preferably used.

The hardening agent is added as a solution and the timing of adding this solution to the coating solution for the protective layer is from 180 minutes to immediately before the coating, preferably from 60 minutes to 10 seconds before the coating. The method and conditions for the mixing are not particularly limited insofar as the effect of the present invention is satisfactorily brought out. Specific examples of the mixing method include a method of mixing the solutions in a tank designed to give a desired average residence time which is calculated from the addition flow rate and the liquid transfer amount to the coater, and a method using a static mixer described in N. Harnby, M. F. Edwards and A. W. Nienow (translated by Koji Takahashi), Ekitai Kongo Gijutsu (Liquid Mixing Technique), Chap. 8, Nikkan Kogyo Shinbun Sha (1989).

The surfactant which can be applied to the present invention is described in JP-A-11-65021 (paragraph No. 0132), the solvent is described in paragraph No. 0133 of the same, the support is described in paragraph No. 0135 of the same, the antistatic or electrically conducting layer is described in paragraph No. 0135 of the same, the method for obtaining a color image is described in paragraph No. 0136 of the same, and the slipping agent is described in JP-A-11-84573 (paragraph Nos. 0061 to 0064) and Japanese Patent Application No. 11-106881 (paragraph Nos. 0049 to 0062).

The transparent support is preferably polyester, particularly polyethylene terephthalate, subjected to a heat treatment in the temperature range of 130 to 185° C. so as to relax the remaining internal distortion generated in the film during the biaxial stretching and thereby eliminate occurrence of thermal shrinkage distortion during the heat development processing. In the case of a heat-developable photosensitive material for medical uses, the transparent support may be colored with a bluish dye (for example, Dye-1 described in Example of JP-A-8-240877) or may be colorless. For the support, a technique for undercoating a water-soluble polyester described in JP-A-11-84574, a styrene-butadiene copolymer described in JP-A-10-166565, or a vinylidene chloride copolymer described in JP-A-2000-39684 and Japanese Patent Application No. 11-106881 (paragraph Nos. 0063 to 0080) is preferably applied. As for the antistatic layer or undercoat, the techniques described in JP-A-56-143430, JP-A-56-143431, JP-A-58-62646, JP-A-56-120519, JP-A-1184573 (paragraph Nos. 0040 to 0051), U.S. Pat. No. 5,575,957 and JP-A-11-223898 (paragraph Nos. 0078 to 0084) can be applied.

The heat-developable photosensitive material is preferably a mono-sheet type (a type where an image can be formed on the heat-developable photosensitive material without using another sheet such as image-receiving material).

The heat-developable photosensitive material may further contain an antioxidant, a stabilizer, a plasticizer, an ultraviolet absorber and a coating aid. These various additives are added to either a photosensitive layer or a non-photosensitive layer. These are described in WO98/36322, EP-A-803764, JP-A-10-186567 and JP-A-10-18568.

The coating of the heat-developable photosensitive material of the present invention may be performed by any method. Various coating operations including extrusion coating, slide coating, curtain coating, dip coating, knife coating, flow coating, and extrusion coating using a hopper of the type described in U.S. Pat. No. 2,681,294 may be used. The extrusion coating or slide coating described in Stephen F. Kistler and Petert M. Schweizer, LIQUID FILM COATING, pp. 399-536, CHAPMAN & HALL (1977) is preferred, with the slide coating being more preferred. An example of the shape of the slide coater used in the slide coating is shown in FIG. 11b.1 of ibid., page 427. If desired, two or more layers may be simultaneously coated using a method described in ibid., pp. 399-536, U.S. Pat. No. 2,761,791 and British Patent 837,095.

The coating solution for the organic silver salt-containing layer used in the present invention is preferably a so-called thixotropy fluid. As for this technique, JP-A-11-52509 can be referred to. The coating solution for the organic silver salt-containing layer used in the present invention preferably has a viscosity at a shear rate of 0.1S-1, of 400 to 100,000 mPa.s, more preferably from 500 to 20,000 mPa.s. At a shear rate of 1,000 S⁻¹, the viscosity is preferably from 1 to 200 mPa.s, more preferably from 5 to 80 mPa.s.

Examples of the technique which can be used in the heat-developable photosensitive material of the present invention also include those described in EP-A-803764, EP-A-883022, WO98/36322, JP-A-56-62648, JP-A-58-62644, JP-A-9-43766, JP-A-9-281637, JP-A-9-297367, JP-A-9-304869, JP-A-9-311405, JP-A-9-329865, JP-A-10-10669, JP-A-10-62899, JP-A-10-69023, JP-A-10-186560, JP-A-10-90823, JP-A-10-171063, JP-A-10-186565, JP-A-10-186567, JP-A-10-186569 to JP-A-10-186572, JP-A-10-197974, JP-A-10-197982, JP-A-10-197983, JP-A-10-197985 to JP-A-10-197987, JP-A-10-207001, JP-A-10-207004, JP-A-10-221807, JP-A-10-282601, JP-A-10-288823,JP-A-10-288824, JP-A-10-307365, JP-A-10-312038, JP-A-10-339934, JP-A-11-7100, JP-A-11-15105, JP-A-11-24200, JP-A-11-24201, JP-A-11-30832, JP-A-11-84574, JP-A-11-65021, JP-A-11-109547, JP-A-11-125880, JP-A-11-129629, JP-A-11-133536 to JP-A-11-133539, JP-A-11-133542, JP-A-11-133543, JP-A-11-223898, JP-A-11-352627, JP-A-11-305377, JP-A-11-305378, JP-A-11-305384, JP-A-11-305380, JP-A-11-316435, JP-A-11-327076, JP-A-11-338096, JP-A-11-338098, JP-A-11-338099, JP-A-11-343420 and Japanese Patent Application Nos. 2000-187298, 2000-10229, 2000-47345, 2000-206642, 2000-98530, 2000-98531, 2000-112059, 2000-112060, 2000-112104, 2000-112064 and 2000-171936.

The heat-developable photosensitive material of the present invention may be developed by any method but usually, the development is performed by raising the temperature of an imagewise exposed heat-developable photosensitive material. The development temperature is preferably from 80 to 250° C., more preferably from 100 to 140° C. The development tile is preferably from 1 to 60 seconds, more preferably from 5 to 30 seconds, still more preferably from 10 to 20 seconds.

The system for the heat development is preferably a plate heater system. The heat development system employing the plate heater system is preferably a heat-developing apparatus described in the method of JP-A-11-133572, which is a heat-developing apparatus of obtaining a visible image by bringing a heat-developable photosensitive material having formed thereon a latent image into contact with heating means in the heat-developing section, where the heating means comprises a plate heater, a plurality of press rollers are disposed to face each other along one surface of the plate heater, and the heat-developable photosensitive material is passed between the press rollers and the plate heater, thereby performing the heat development. The plate heater is preferably divided into 2 to 6 stages and the temperature at the leading end is preferably lowered by approximately from 1 to 10° C. Such a method is described also in JP-A-54-30032, where the water content or organic solvent contained in the heat-developable photosensitive material can be excluded out of the system and the heat-developable photosensitive material can be prevented from the change in the support shape which is caused due to abrupt heating of the heat-developable photosensitive layer.

The heat-developable photosensitive material of the present invention may be exposed by any method but a laser ray is preferably used as the light source for exposure. The laser for use in the present invention is preferably a gas laser (e.g., Ar⁺, He—Ne), a YAG laser, a dye laser or a semiconductor laser. Also, a semiconductor laser combined with a second harmonic generating device may be used. A gas or semiconductor laser capable of emitting light from red to infrared is preferred.

Examples of the medical-use laser imager equipped with an exposure section and a heat-development section include Fuji Medical Dry Laser Imager FM-DP L. The MF-DP L is described in Fuji Medical Review, No. 8, pp. 39-55 and, of course, the technique described in this publication can be applied as the laser imager for the heat-developable photosensitive material of the present invention. Furthermore, the present invention can also be used as a heat-developable photosensitive material for a laser imager in the “AD network” which is proposed as a network system adaptable for the DICOM standard from Fuji Medical System.

The heat-developable photosensitive material of the present invention is suitable for the formation of a black-and-white image by the silver image and is preferably used as a heat-developable photosensitive material for medical diagnosis, a heat-developable photosensitive material for industrial photography, a heat-developable photosensitive material for printing or a heat-developable photosensitive material for COM.

The present invention is described in greater detail below by referring to Examples, however, the present invention should not be construed as being limited thereto,

### EXAMPLE 1

Preparation of PET Support

PET having an intrinsic viscosity IV=0.66 (measured in phenol/tetrachloroethane=6/4 (by weight) at 25° C.) was obtained by an ordinary method using terephthalic acid and ethylene glycol. The PET was pelletized, dried at 130° C. for 4 hours, melted at 300° C., extruded from a T-die and rapidly cooled to prepare an unstretched film having a thickness sufficiently large to give a thickness of 175 μm after the heat setting.

This film was vertically stretched to 3.3 times using rolls different in the peripheral speed and then horizontally stretched to 4-5 times by a tenter. At this time, the temperatures were 110° C. and 130° C., respectively. Subsequently, the film was heat set at 240° C. for 20 seconds and horizontally relaxed by 4% at the same temperature. Thereafter, the chuck part of the tenter was slit, both edges of the film were knurled, and the film was taken up at 4 kg/cm² (4×10⁴ Pa) to obtain a roll having a thickness of 175 μm.

Surface Corona Treatment

Both surfaces of the support was treated at room temperature at 20 m/min using a solid state corona treating machine Model 6KVA manufactured by PILLAR. From the current and voltage read, it was found that the support was treated to 0.375 kV·A·min/m² at this time. The treatment frequency here was 9.6 kHz and the gap clearance between the electrode and the dielectric roll was 1.6 mm.

Preparation of Undercoated Support

(1) Preparation of Coating Solution for Undercoat Layer
Formulation (1) (for undercoat layer in the photosensitive
layer side):

| | |
|---|---|
| PESRESIN A-515G5 (30% by mass solution) | 234 g |
| produced by Takantatsu Yushi K.K. | |
| Polyethylene glycol monononylphenyl ether | 21.5 g |
| (average ethylene oxide number: 8.5), 10% | |
| by mass solution | |
| MP-1000 (polymer fine particle, average | 0.91 g |
| particle size; 0.4 μm) produced by Soken | |
| Kagaku K.K. | |
| Distilled water | 744 ml |

Formulation (2) (for first layer on back surface):

| | |
|---|---|
| Styrene/butadiene copolymer latex (solid | 158 g |
| content: 40% by mass, styrene/butadiene: | |
| 68/32 (by weight)) | |
| 2,4-Dichloro-6-hydroxy-S-triazine sodium | 20 g |
| salt, 8% by mass aqueous solution | |
| Sodium laurylbenzenesulfonate, 1% by mass | 10 ml |
| aqueous solution | |
| Distilled water | 554 ml |

Formulation (3) (for second layer on back surface):

| | |
|---|---|
| SnO₂/SbO (9/1 by mass, average particle | 84 g |
| size: 0.038 μm, 17% by mass dispersion) | |
| Gelatin (10% by mass aqueous solution) | 89.2 g |
| METROSE TC-5 (2% by mass aqueous solution) | 8.6 g |
| produced by Shin-Etsu Chemical Co., Ltd. | |
| MP-1000 produced by Soken Kagaku K.K. | 0.01 g |
| 1% By mass aqueous solution of sodium | 10 ml |
| dodecylbenzenesulfonate | |
| NaOH (1% by mass) | 6 ml |
| PROXEL (produced by ICI) | 1 ml |
| Distilled water | 805 ml |

Preparation of Undercoated Support

Both surfaces of the 175 μm-thick biaxially stretched polyethylene terephthalate support obtained above each was subjected to the above-described corona discharge treatment and on one surface (photosensitive layer surface), the undercoat coating solution of formulation (1) was coated by a wire bar to have a wet coated amount of 6.6 ml/m2 (per one surface) and dried at 180° C. for 5 minutes. Thereafter, on the rear surface thereof (back surface), the undercoat coating solution of formulation (2) was coated by a wire bar to have a wet coated amount of 5.7 mil/m² and dried at 180° C. for 5 minutes. Furthermore, on the rear surface (back surface), the undercoat coating solution of formulation (3) was coated by a wire bar to have a wet coated amount of 7.7 ml/m² and dried at 180° C. for 6 minutes, thereby obtaining an undercoated support.

Preparation of Coating Solution for Back Surface

Preparation of Solid Fine Dispersion Solution (a) of Base Precursor

64 g of Base Precursor Compound 11, 28 g of diphenylsulfone and 10 g of surfactant Demole N produced by Kao Corporation were mixed with 220 ml of distilled water and the mixed solution was dispersed using beads in a sand mill (¼ Gallon Sand Grinder Mill, manufactured by Imex K.K.) to obtain Solid Fine Particle Dispersion Solution (a) of Base Precursor Compound, having an average particle size of 0.2 μm.

Preparation of Solid Fine Particle Dispersion Solution of Dye

9.6 g of Cyanine Dye Compound 13 and 5.8 g of sodium p-dodecylbenzenesulfonate were mixed with 305 ml of distilled water and the mixed solution was dispersed using beads in a sand mill (¼ Gallon Sand Grinder Mill, manufactured by Imex K.K.) to obtain a solid fine particle dispersion solution of dye, having an average particle size of 0.2 μm.

Preparation of Coating Solution for Antihalation Layer

17 g of gelatin, 9.6 g of polyacrylamide, 70 g of Solid Fine Particle Dispersion Solution (a) of Base Precursor obtained above, 56 g of the solid fine particle dispersion solution of dye obtained above, 1.5 g of monodisperse polymethyl methacrylate fine particles (average particle size: 8 μm, standard deviation of particle size: 0.4), 0.03 g of benzisothiazolinone, 2.2 g of sodium polyethylenesulfonate, 0.2 g of Blue Dye Compound 14, 3.9 g of Yellow Dye Compound 15 and 844 ml of water were mixed to prepare a coating solution for the antihalation layer.

Preparation of Coating Solution for Protective Layer on Back Surface

In a container kept at 40° C., 50 g of gelatin, 0.2 g of sodium polystyrenesulfonate, 2.4 g of N,N-ethylenebis-(vinylsulfonacetanide), 1 g of sodium tert-octylphenoxy-ethoxyethanesulfonate, 30 mg of benzisothazolinone, 37 mg of fluorine-containing surfactant (F-1: N-perfluorooctylsulfonyl-N-propylalanine potassium salt), 0.15 g of fluorine-containing surfactant (F-2; polyethylene glycol mono(N-perfluorooctylsulfonyl-N-propyl-2-azinoethyl ether[ethylene oxide average polymerization degree; 15]), 64 mg of fluorine-containing surfactant (F-3), 32 mg of fluorine-containing surfactant (F-4), 8.8 g of acrylic acid/ethyl acrylate copolymer (copolymerization weight ratio: 5/95), 0.6 g of Aerosol OT (produced by American Cyanamide) and 1.8 g as liquid paraffin of liquid paraffin emulsified product and 950 ml of water were mixed to prepare a coating solution for the protective layer on the back surface.

Preparation of Silver Halide Emulsion 1

A solution was obtained by adding 3.1 ml of a 1% by mass potassium bromide solution, 3.5 ml of sulfuric acid in a concentration of 0.5 mol/L and 31.7 g of phthalized gelatin to 1,421 ml of distilled water. While stirring the solution in a stainless steel-made reaction pot and thereby keeping the liquid temperature at 30° C., the entire amount of Solution A resulting from dilution to 95.4 ml by adding distilled water to 22.22 g of silver nitrate and the entire amount of Solution B resulting from dilution of 15.3 g of potassium bromide and 0.8 g of potassium iodide with distilled water to a volume of 97.4 ml were added to the reaction pot at a constant flow rate over 45 seconds. Subsequently, 10 ml of a 3.5% by mass aqueous hydrogen peroxide solution was added and further, 10.8 ml of a 10% by mass aqueous solution of benzimidazole was added. Thereafter, Solution C resulting from dilution to 317.5 ml by adding distilled water to 51.86 g of silver nitrate and Solution D resulting from dilution of 44.2 g of potassium bromide and 2.2 g of potassium iodide to a volume of 400 ml were added by a controlled double jet method such that the entire amount of Solution C was added at a constant flow rate over 20 minutes and Solution D was added while maintaining the pAg at 8.1. 10 Minutes after the initiation of addition of Solution C and Solution D, the entire amount of potassium hexachloroiridate(III) was added to give a coverage of 1×10⁻⁴ mol per mol of silver. Also, 5 seconds after the completion of addition of Solution C, the entire amount of an aqueous potassium hexacyanoferrate(II) solution in 3×10⁻⁴ mol per mol of silver was added. Then, the pH was adjusted to 3.8 using sulfuric acid in a concentration of 0.5 mol/L and after stirring was stopped, the solution was subjected to precipitation/desalting/water washing steps. Furthermore, the pH was adjusted to 5.9 using sodium hydroxide in a concentration of 1 mol/L, whereby a silver halide dispersion at a pAg of 8.0 was prepared.

While stirring the silver halide dispersion obtained above and thereby keeping at 38PC, 5 ml of a methanol solution containing 0.34% by mass of 1,2-benzisothiazolin-3-one was added and after 40 minutes, a methanol solution containing Spectral Sensitizing Dye A and Spectral Sensitizing Dye B at a molar ratio of 1:1 was added in an amount of 1.2×10⁻³ mol as a total of Spectral Sensitizing Dyes A and B per mol of silver. After 1 minute, the temperature was elevated to 47° C. and 20 minutes after the elevation of temperature, a methanol solution of sodium benzenethiosulfate was added in an amount of 7.6×10⁻⁵ mol per mol of silver. After 5 minutes, a methanol solution of Tellurium Sensitizer C was added in an amount of 2.9×10⁻⁴ mol per mol of silver and then, the solution was ripened for 91 minutes. Furthermore, 1.3 ml of a 0.8% by mass methanol solution of N,N′-dihydroxy-N″-diethylmelamine was added and after 4 minutes, a methanol solution of 5-methyl-2-mercaptobenzimidazole and a methanol solution of 1-phenyl-2-heptyl-5-mercapto-1,3,4-triazole were added in an amount of 4.8×10⁻³ mol and 5.4×10⁻³ mol, respectively, per mol of silver to prepare Silver Halide Emulsion 1.

The grains in the silver halide emulsion prepared were silver iodobromide grains having an average equivalent-sphere diameter of 0.042 μm and a coefficient of variation in the sphere-equivalent diameter of 20% and uniformly containing 3.5 mol % of iodide. The grain size and the like were determined as an average of 1,000 grains using an electron microscope. The percentage of {100} face in this grain was calculated as 80% in accordance with the Kubelka-Munk equation.

Preparation of Silver Halide Emulsion 2

The preparation of Silver Halide Emulsion 2 was performed in the same manner as in the preparation of Silver Halide Emulsion 1 except that the liquid temperature at the grain formation was changed from 30° C. to 47° C., Solution B was obtained by diluting 15.9 g of potassium bromide with distilled water to a volume of 97.4 ml, Solution D was obtained by diluting 45.8 g of potassium bromide with distilled water to a volume of 400 ml, Solution C was added over 30 minutes and potassium hexacyanoferrate(II) was excluded. The obtained solution was subjected to the steps of precipitation/desalting/water washing/dispersion in the same manner as Silver Halide Emulsion 1. Thereafter, Silver Halide Emulsion 2 was obtained by performing the spectral sensitization, the chemical sensitization, the addition of 5-methyl-2-mercaptobenzimidazole and 1-phenyl-2-heptyl-5-mercapto-1,3,4-triazole in the same manner as in the preparation of Silver Halide Emulsion 1 except that the amount added of the methanol solution containing Spectral Sensitizing Dye A and Spectral Sensitizing Dye B at a molar ratio of 1:1 was changed to 7.5×10⁻⁴ mol as a total amount of Spectral Sensitizing Dyes A and B per mol of silver, the amount of Tellurium Sensitizer C added was changed to 1.1×10⁻⁴ mol per mol of silver and the amount of 1-phenyl-2-heptyl-5-mercapto-1,3,4-triazole added was changed to 3.3×10⁻³ mol per mol of silver. The emulsion grains of Silver Halide Emulsion 2 were pure silver bromide cubic grains having an equivalent-sphere diameter of 0.080 μm and a coefficient of variation in the equivalent-sphere diameter of 20%.

Preparation of Silver Halide Emulsion 3

The preparation of Silver Halide Emulsion 3 was performed in the same manner as in the preparation of Silver Halide Emulsion 1 except that the liquid temperature at the grain formation was changed from 30° C. to 27° C. The obtained solution was subjected to the steps of precipitation/desalting/water washing/dispersion in the same manner as Silver Halide Emulsion 1, Thereafter, Silver Halide Emulsion 3 was obtained in the same manner as Silver Halide Emulsion 1 except that the amount added of the solid dispersion (aqueous gelatin solution) containing Spectral Sensitizing Dye A and Spectral Sensitizing Dye B at a molar ratio of 1:1 was changed to 6×10⁻³ mol as a total amount of Spectral Sensitizing Dyes A and B per mol of silver and the amount of Tellurium Sensitizer C added was changed to 5.2×10⁻⁴ mol per mol of silver. The emulsion grains of Silver Halide Emulsion 3 were silver iodobromide grains having an equivalent-sphere diameter of 0.034 μm and a coefficient of variation in the equivalent-sphere diameter, of 20% and uniformly containing 3.5 mol % of iodide.

Preparation of Silver Halide Mixed Emulsion A for Coating Solution

70% by mass of Silver Halide Emulsion 1, 15% by mass of Silver Halide Emulsion 2 and 15% by mass of Silver Halide Emulsion 3 were dissolved and thereto, a 1% by mass aqueous solution of benzothiazolium iodide were added in an amount of 7×10⁻³ mol per mol of silver. Furthermore, water was added to make a silver halide content of 38.2 g as silver per kg of the silver halide mixed emulsion for the coating solution.

Preparation of Organic Silver Salt Dispersions A to G

258.5 mol of organic silver, 423 L of distilled water, 49.2 L of an aqueous NaOH solution in a concentration of 5 mol/L and 120 L of tert-butanol were mixed to have a composition shown in Table 1 and reacted with stirring at 75° C. for 1 hour to obtain a sodium organic acid solution. Separately, 206.2 L (pH: 4.0) of an aqueous solution containing 40.4 kg of silver nitrate was prepared and kept at 10° C. To a reactor containing 635 L of distilled water and 30 L of tert-butanol and kept at 30° C., the entire amount of the sodium organic acid solution prepared above and the entire amount of the aqueous silver nitrate solution prepared above were added at a constant flow rate while thoroughly stirring over 93 minutes and 15 seconds and over 90 minutes, respectively. At this time, only the aqueous silver nitrate solution was added for 11 minutes after the initiation of addition of the aqueous silver nitrate solution, then the addition of the sodium organic acid solution was started, and only the sodium organic acid solution was added for 14 minutes and 15 seconds after the completion of addition of the aqueous silver nitrate solution. The temperature in the reactor here was set to the temperature shown in Table 1 and the ambient temperature was controlled to keep a constant liquid temperature. Furthermore, the pipeline for the addition system of the sodium organic acid solution was kept warm by circulating warm water through the outer tube of a double pipe and the outlet liquid temperature at the addition nozzle tip was adjusted to 75° C. The pipeline for the addition system of the aqueous silver nitrate solution was kept warm by circulating cold water to the outside of the double pipe. The site where the sodium organic acid solution was added and the site where the aqueous silver nitrate solution was added were disposed to make a symmetry centered in the stirring axis and each was adjusted to the height not to come into contact with the reaction solution.

Ripening/centrifugal Filtration

After the completion of addition of the sodium organic acid solution, the mixed solution was allowed to stand for 20 minutes while stirring at the same temperature and then, the temperature was elevated to 35° C. over 30 minutes, followed by ripening for 210 minutes. Immediately after the completion of ripening, the solid contents were separated by centrifugal filtration and washed with water until the filtering water had a conductivity of 30 μS/cm. At this time, the operation of adding pure water to the wet cake to provide a slurry state was performed three times so as to accelerate the reduction of conductivity. The obtained wet cake of organic silver was centrifuged for 1 hour with a centrifugal force G of 700. Here, G is expressed by 1.119×10⁻⁵ x radius (cm) of container x rotational frequency (rpm)². The thus-obtained wet cake of organic silver had a solid content (measured by drying 1 g of wet cake at 110° C. for 2 hours) of 44%.

Preliminary Dispersion

To the wet cake corresponding to 260 kg of dry content, 19.3 kg of polyvinyl alcohol (PVA-217, trade name) and water were added to make a total amount of 1,000 kg. Thereafter, the wet cake was formed into a slurry by means of a dissolver blade and then preliminarily dispersed using a homomixer (Model PM-10, manufactured Mizuha Kogyo).

Final Dispersion

The stock solution after the preliminary dispersion was treated three times in a dispersing machine (Microfluidizer M-610, trade name, manufactured by Microfluidex international Corporation; using Z-type interaction chamber) of which pressure was adjusted to 1,260 kg/cm² (12.6 MPa) to obtain an organic silver salt dispersion (silver behenate dispersion). The shape characteristic values of this dispersion were the same as those after the water washing. In the cooling operation, a coiled heat exchanger was installed before and after the interaction chamber and the refrigerant temperature was controlled to set the dispersion temperature at 18° C.

The organic silver salt grains contained in the thus-obtained Organic Silver Salt Dispersions A to G had a volume weighed average diameter (equivalent-sphere diameter), a coefficient of variation in the volume weighed average diameter, a ratio (length/width ratio) of long side c to short side b of a grain, and an aspect ratio shown in Table 1. The grain size was measured using Master Sizer X manufactured by Malvern Instruments Ltd.

Preparation of Organic Silver Salt Dispersions H to K

(1) Preparation of Organic Acid Salt Solution

258.5 mol of an organic acid having a composition shown in Table 1, 423 L of distilled water, 49.2 L of an aqueous NaOH solution in a concentration of 5 mol/L, and 120 L of tert-butyl alcohol were mixed and reacted at 75° C. for 1 hour while stirring to obtain a sodium organic acid solution.

(2) Preparation of Silver Ion-Containing Solution

206.2 L of an aqueous solution (pH: 4.0) containing 40.4 kg of silver nitrate was prepared and kept at 10° C.

(3) Preparation of Reaction Bath Solution

A reactor containing 635 L of distilled water and 30 L of tert-butyl alcohol was kept at a temperature at 30° C.

A small crystallization unit shown in FIG. 1, was used as closed mixing means The solutions in (1 ), (2) and (3) were weighed and charged into tanks 12, 11 and 20, respectively, and circulated through a pump 7 at a flow rate of 250 L/min. More specifically, while stirring a pipeline mixer Model LR-I (18 in FIG. 1) manufactured by Mizuho Kogyo K.K. at 2,500 rpm, (1) and (2) were added. The solution in (2) was added at a constant flow rate over 100 minutes and the solution in (1), of which addition was started 1 minute after the initiation of addition of (2), was added at a constant flow rate over 74 minutes to use the amount corresponding to 90% of the total amount added. 10 Minutes after the completion of addition of (2), the entire amount (corresponding to 10% of the total amount added) of the remaining (1) was added to the liquid surface of (3) at a constant flow rate over 7 minutes. During this addition, (3) was stirred vigorously as much as possible within the range of not involving bubbling. The temperature control was performed using a heat exchanger 19 in addition to the cooling of a tank 20. More specifically, the temperature was controlled by supplying water of an appropriate temperature at 20 L/min to the jackets of the heat exchanger 19 and the tank 20 to give a temperature shown in Table 1.

The pipeline for the addition system of organic acid salt (sodium organic acid) solution was kept warm using a double pipe and the temperature of warming water was controlled such that the outlet liquid temperature at the addition nozzle tip became 75° C. The pipeline for the addition system of aqueous silver nitrate aqueous solution was kept warm by circulating cold water to the outside of the double pipe.

The resulting mixture was subjected to ripening, & centrifugal filtration, preliminary dispersion and final dispersion treatments.

The organic silver salt grains contained in the thus-obtained Organic Silver Salt Dispersions H to K had a volume weighed average diameter (equivalent-sphere A diameter), a coefficient of variation in the volume weighed average diameter, a ratio (length/width ratio) of long side c to short side b of a grain, and an aspect ratio shown in Table 1. The grain size was measured using Master Sizer X manufactured by Malvern Instruments Ltd.

Preparation of Organic Silver Salt Dispersions L to O

To an organic silver salt charge solution obtained in the same manner as in the preparation of Organic Silver Salt dispersions H to K, PVA217 was added in the solution state where 7.4 g was dissolved in 74 g of water based on 100 g of dry solid contents. The resulting solution was treated once using the above-described Microfluidizer except for adjusting the pressure to 600 kg/cm² (6 MPa), The obtained solution was transferred to an ultrafiltration device and desalted. The ultrafiltration device was fundamentally constructed by a tank for storing the organic silver salt dispersion and a pump for feeding the stock dispersion to the ultrafiltration module, and equipped with a flow meter for measuring replenishing pure water, a flow meter for measuring transmitted water, a pump for backward washing, and the like. The membrane module used was hollow yarn-type ACP-1050 produced by Asahi Chemical Industry Co., Ltd., the liquid transfer flow rate was 18 l/min, and the difference in the pressure between before and after module was 1.0 kg/cm² (1×10⁴ Pa). The processing solution was kept at a temperature of 17° C. or less during the processing.

When the electrical conductivity was dropped to 100 μS/cm, the supply of pure water was stopped and the solution was concentrated to 26 wt %. The resulting solution was treated twice using the above-described Microfluidizer by adjusting the pressure to 1750 kg/cm² (17.5 MPa) to obtain Organic Silver Salt Dispersions H to K. The solid concentration was measured by digital gravimeter Model DA-300 manufactured by Kyoto Denshi K.K. and finally verified by the bone dry weight.

The organic silver salt gains contained in the thus-obtained Organic Solver Salt Dispersions L to O had a volume weighed average diameter (equivalent-sphere diameter), a coefficient of variation in the volume weighed average diameter, a ratio (length/width ratio) of long side C to short side b of a grain, and an aspect ratio shown in Table 1. The grain size was measured using Master Sizer X manufactured by Malvern Instruments Ltd.

TABLE 1

| Organic | Content (in mol %) | | | Reaction | Volume Weighed | Coefficient | | |
|---|---|---|---|---|---|---|---|---|
| Silver Salt | Silver | Silver | Silver | Temperature | Average | of Variation | Length/Width | Aspect |
| Dispersion | Stearate | Arachidate | Behenate | (° C.) | diameter (μm) | (%) | Ratio | Ratio |
| A | 2 | 5 | 93 | 30 | 0.48 | 14 | 1.5 | 18 |
| B | 0.5 | 8 | 91.5 | 30 | 0.48 | 13.5 | 1.7 | 25 |
| C | 0 | 4 | 96 | 30 | 0.42 | 12 | 1.1 | 13 |
| D | 0 | 2 | 98 | 30 | 0.4 | 11 | 1 | 10 |
| E | 1.5 | 10.5 | 88 | 30 | 0.5 | 16 | 4 | 32 |
| F | 0 | 2 | 98 | 45 | 0.55 | 18 | 8 | 27 |
| G | 0 | 2 | 98 | 65 | 1.1 | 22 | 12 | 42 |
| H | 2 | 5 | 93 | 30 | 0.48 | 14 | 1.5 | 18 |
| I | 0 | 4 | 96 | 30 | 0.42 | 12 | 1.1 | 13 |
| J | 0 | 2 | 98 | 30 | 0.4 | 12 | 1 | 10 |
| K | 0 | 2 | 98 | 65 | 0.55 | 18 | 8 | 27 |
| L | 2 | 5 | 93 | 30 | 0.48 | 14 | L.5 | 18 |
| M | 0 | 4 | 96 | 30 | 0.42 | 12 | 1.1 | 13 |
| N | 0 | 2 | 98 | 30 | 0.4 | 12 | 1 | 10 |
| O | 0 | 2 | 98 | 65 | 0.55 | 18 | 8 | 27 |

Preparation of Reducing Agent 1 Dispersion

To 10 kg of Reducing Agent 1 (1,1-bis(2-hydroxy-3,5-dimethylphenyl)-3,5,5-trimethylhexane) and 10 kg of a 20% by mass aqueous solution of modified polyvinyl alcohol (Poval MP203, produced by Kuraray Co., Ltd.), 16 kg of water was added and thoroughly mixed to form a slurry. This slurry was sent by a diaphragm pump and dispersed in a horizontal sand mill (UVM-2, manufactured by Imex K.K.) filled with zirconia beads having an average diameter of 0.5 mm for 3 hours and 30 minutes. Thereafter, 0.2 g of benzisothiazolinone sodium salt and water were added to adjust the reducing agent concentration to 25% by mass, thereby obtaining Reducing Agent 1 Dispersion. The reducing agent particles contained in the thus-obtained Reducing Agent 1 Dispersion had a median diameter of 0.42 μm and a maximum particle size of 2.0 μm or less. The obtained Reducing Agent 1 Dispersion was filtered through a polypropylene-made filter having a pore size of 10.0 μm to remove foreign matters such as dust and then housed.

Preparation of Reducing Agent 2 Dispersion

To 10 kg of Reducing Agent 2 (2,2′-isobutylidene-bis-(4,6-dimethylphenol)) and 10 kg of a 20% by mass aqueous solution of modified polyvinyl alcohol (Poval MP203, produced by Kuraray Co., Ltd.), 16 kg of water was added and thoroughly mixed to form a slurry. This slurry was sent by a diaphragm pump and dispersed in a horizontal sand mill (UVM-2, manufactured by Imex K.K.) filled with zirconia beads having an average diameter of 0.5 mm for 3 hours and 30 minutes. Thereafter, 0.2 g of benzisothiazolinone sodium salt and water were added to adjust the reducing agent concentration to 25% by mass, thereby obtaining Reducing Agent 2 Dispersion. The reducing agent particles contained in the thus-obtained Reducing Agent 2 Dispersion had a median diameter of 0.38 μm and a maximum particle size of 2.0 μm or less. The obtained Reducing Agent 2 Dispersion was filtered through a polypropylene-made filter having a pore size of 10.0 to remove foreign matters such as dust and then housed.

Preparation of Reducing Agent Complex 3 Dispersion

To 10 kg of Reducing Agent Complex 3 (a 1:1 complex of 2,2′-methylenebis-(4-ethyl-6-tert-butylphenol) and triphenylphosphine oxide), 0.12 kg of triphenylphosphine oxide and 16 kg of a 10% by mass aqueous solution of modified polyvinyl alcohol (Poval MP203, produced by Kuraray Co., Ltd.), 7.2 kg of water was added and thoroughly mixed to form a slurry. This slurry was sent by a diaphragm pump and dispersed in a horizontal sand mill (UVM-2, manufactured by Imex K.K.) filled with zirconia beads having an average diameter of 0.5 mm for 4 hours and 30 minutes. Thereafter, 0.2 g of benzisothiazolinone sodium salt and water were added to adjust the reducing agent concentration to 25% by mass, thereby obtaining Reducing Agent Complex 3 Dispersion. The reducing agent complex particles contained in the thus-obtained Reducing Agent Complex 3 Dispersion had a median diameter of 0.46 μm and a maximum particle size of 1.6 μm or less. The obtained Reducing Agent 3 Dispersion was filtered through a polypropylene-made filter having a pore size of 3.0 μm to remove foreign matters such as dust and then housed.

Preparation of Reducing Agent 4 Dispersion

To 10 kg of Reducing Agent 4 (2,2′-methylenebis-(4-ethyl-6-tert-butylphenol)) and 20 kg of a 10% by mass aqueous solution of modified polyvinyl alcohol (Poval MP203, produced by Kuraray Co., Ltd.),. 6 kg of water was added and thoroughly mixed to form a slurry. This slurry was sent by a diaphragm pump and dispersed in a horizontal sand mill (UVM-2, manufactured by Imex K.K.) filled with zirconia beads having an average diameter of 0.5 mm for 3 hours and 30 minutes. Thereafter, 0.2 g of benzisothiazolinone sodium salt and water were added to adjust the reducing agent concentration to 25% by mass, thereby obtaining Reducing Agent 4 Dispersion. The reducing agent particles contained in the thus-obtained Reducing Agent 4 Dispersion had a median diameter of 0.40 μm and a maximum particle size of 1.5 μm or less. The obtained Reducing Agent 4 Dispersion was filtered through a polypropylene-made filter having a pore size of 3.0 μm to remove foreign matters such as dust and then housed.

Preparation of Reducing Agent 5 Dispersion

To 10 kg of Reducing Agent 5 (2,2′-methylenebis-(4-methyl-6-tert-butylphenol)) and 20 kg of a 10% by mass aqueous solution of modified polyvinyl alcohol (Poval MP203, produced by Kuraray Co., Ltd.), 6 kg of water was added and thoroughly mixed to form a slurry. This slurry was sent by a diaphragm pump and dispersed in a horizontal sand mill (UVM-2, manufactured by Imex K.K.) filled with zirconia beads having an average diameter of 0.5 mm for 3 hours and 30 minutes. Thereafter, 0.2 g of benzisothiazolinone sodium a salt and water were added to adjust the reducing agent concentration to 25% by mass, thereby obtaining Reducing Agent 5 Dispersion. The reducing agent particles contained in the thus-obtained Reducing Agent 5 Dispersion had a median diameter of 0.38 μm and a maximum particle size of 1.5 μm or less. The obtained Reducing Agent 5 Dispersion was filtered through a polypropylene-made filter having a pore size of 3.0 μm to remove foreign matters such as dust and then housed.

Preparation of Hydrogen Bond-Forming Compound 2 Dispersion

To 10 kg of Hydrogen Bond-Forming Compound 2 (tri(4-tert-butylphenyl)phosphine oxide) and 20 kg of a 10% by mass aqueous solution of modified polyvinyl alcohol (Poval MP203, produced by Kuraray Co., Ltd.), 10 kg of water was added and thoroughly mixed to form a slurry. This slurry was sent by a diaphragm pump and dispersed in a horizontal sand mill (UVM-2, manufactured by Imex K.K.) filled with zirconia beads having an average diameter of 0.5 mm for 3 hours and 30 minutes. Thereafter, 0.2 g of benzisothiazolinone sodium salt and water were added to adjust the hydrogen bond-forming compound concentration to 22% by mass, thereby obtaining Hydrogen Bond-Forming Compound 2 Dispersion. The hydrogen bond-forming compound particles contained in the thus obtained Hydrogen Bond-Forming compound 2 Dispersion had a median diameter of 0.35 μm and a maximum particle size of 1.5 μm or less. The obtained Hydrogen Bond-Forming Compound 2 Dispersion was filtered through a polypropylene-made filter having a pore size of 3.0 μm to remove foreign matters such as dust and then housed.

Preparation of Organic Polyhalogen Compound 1 Dispersion

To 10 kg of Organic Polyhalogen Compound 1 (2-tribromomethanesulfonylnaphthalene) and 10 kg of a 20% by mass aqueous solution of modified polyvinyl alcohol (Poval MP203, produced by Kuraray Co., Ltd.), 0.4 kg of a 20% by mass aqueous solution of sodium triisopropyl-naphthalenesulfonate and 16 kg of water were added and thoroughly mixed to form a slurry. This slurry was sent by a diaphragm pump and dispersed in a horizontal sand mill (UVM-2, manufactured by Imex K.K.) filled with zirconia beads having an average diameter of 0.5 mm for 5 hours. Thereafter, 0.2 g of benzisothiazolinone sodium salt and water were added to adjust the organic polyhalogen compound concentration to 23.5% by mass, thereby obtaining Organic Polyhalogen Compound 1 Dispersion. The organic polyhalogen compound particles contained in the thus-obtained Organic Polyhalogen Compound 1 Dispersion had a median diameter of 0.36 μm and a maximum particle size of 2.0 μm or less. The obtained Organic Polyhalogen Compound 1 Dispersion was filtered through a polypropylene-made filter having a pore size of 10.0 μm to remove foreign matters such as dust and then housed.

Preparation of Organic Polyhalogen Compound 2 Dispersion

To 10 kg of organic Polyhalogen Compound 2 (tribromomethanesulfonylbenzene) and 10 kg of a 20% by mass aqueous solution of modified polyvinyl alcohol (Poval MP203, produced by Kuraray Co., Ltd.), 0.4 kg of a 20% by mass aqueous solution of sodium triisopropylnaphthalenesulfonate and 14 kg of water were added and thoroughly mixed to form a slurry. This slurry was sent by a diaphragm pump and dispersed in a horizontal sand mill (UVM-2, manufactured by Imex K.K.) filled with zirconia beads having an average diameter of 0.5 mm for 5 hours. Thereafter, 0.2 g of benzisothiazolinone sodium salt and water were added to adjust the organic polyhalogen compound concentration to 26% by mass, thereby obtaining organic Polyhalogen Compound 2 Dispersion. The organic polyhalogen compound particles contained in the thus-obtained Organic Polyhalogen Compound 2 Dispersion had a median diameter of 0.41 μm and a maximum particle size of 2.0 μm or less. The obtained Organic Polyhalogen Compound 2 Dispersion was filtered through a polypropylene-made filter having a pore size of 10.0 μm to remove foreign matters such as dust and then housed.

Preparation of Organic Polyhalogen Compound 3 Dispersion

To 10 kg of Organic Polyhalogen Compound 3 (N-butyl-3-tribromomethanesulfonylbenzamide) and 20 kg of a 10% by mass aqueous solution of modified polyvinyl alcohol (Poval MP203, produced by Kuraray Co., Ltd.), 0.4 kg of a 20% by mass aqueous solution of sodium triisopropyl-naphthalenesulfonate and 8 kg of water were added and thoroughly mixed to form a slurry. This slurry was sent by a diaphragm pump and dispersed in a horizontal sand mill (UVM-2, manufactured by Imex K.K.) filled with zirconia beads having an average diameter of 0.5 mm for 5 hours. Thereafter, 0,2 g of benzisothiazolinone sodium salt and water were added to adjust the organic polyhalogen compound concentration to 25% by mass. The resulting dispersion solution was heated at 40° C. for 5 hours to obtain Organic Polyhalogen Compound 3 Dispersion. The organic polyhalogen compound particles contained in the thus-obtained Organic Polyhalogen Compound 3 Dispersion had a median diameter of 0.36 μm and a maximum particle size of 1.5 μm or less. The obtained Organic Polyhalogen Compound 3 Dispersion was filtered through a polypropylene-made filter having a pore size of 3.0 μm to remove foreign matters such as dust and then housed.

Preparation of Phthalazine Compound 1 Solution

8 kg of modified polyvinyl alcohol MP203 produced by Kuraray Co., Ltd. was dissolved in 174.57 kg of water and thereto, 3.15 kg of a 20% by mass aqueous solution of sodium triisopropylnaphthalenesulfonate and 14.28 kg of a 70% by mass aqueous solution of Phthalazine Cotnpound 1 (6-isopropylphthalazine) were added to prepare a 5% by mass solution of Phthalazine Compound 1.

Preparation of Aqueous Mercapto Compound 1 Solution

7 g of Mercapto Compound 1 (1-(3-sulfophenyl)-5-mercaptotetrazole sodium salt) was dissolved in 993 g of water to prepare a 0.7% by mass aqueous solution.

Preparation of Pigment 1 Dispersion

To 64 g of C.I. Pigment Blue 60 and 6.4 g of Demole N produced by Kao Corporation, 250 g of water was added and thoroughly mixed to form a slurry. This slurry was placed in a vessel together with 800 g of zirconia beads having an average diameter of 0.5 mm and dispersed for 25 hours in a dispersing machine (¼G Sand Grinder Mill, manufactured by Imex K.K.) to obtain pigment 1 Dispersion. The pigment particles contained in the thus-obtained Pigment 1 Dispersion had an average particle size of 0.21 μm.

Preparation of SBR Latex Solution

An SBR latex having a Tg of 23° C. was prepared as follows.

Using ammonium persulfate as a polymerization initiator and an anionic surfactant as an emulsifier, 70.5 mass of styrene, 26.5 mass of butadiene and 3 mass of acrylic acid were emulsion-polymerized and then aged at 80° C. for 8 hours. The resulting solution was cooled to 40° C. and adjusted to a pH of 7.0 with aqueous ammonia and thereto, SANDET BL produced by Sanyo Kasei K.K. was added to 0.22%. Thereafter, an aqueous 5% sodium hydroxide solution was added to adjust the pH to 8.3 and further, the pH was adjusted to 8.4 with aqueous ammonia. At this time, Na⁺ ion and NH₄⁺ ion were used at a molar ratio of 1:2.3. To 1 kg of this solution, 0.15 ml of a 7% aqueous solution of benzoisothiazolinone sodium salt was added to prepare an SBR latex solution.

SBR Latex (Latex of -St(70.5)-Bu(26.5)-AA(3)-):

Tg; 23° C.

Average particle size: 0.1 μm

Concentration; 43% by mass

Equilibrium moisture content at 25° C. and 60% RU:

0.6% by mass

Ion conductivity; 4.2 mS/cm (the measurement of ion conductivity was performed by measuring the latex stock solution (43% by mass) at 25° C. using a conductivity meter CN-30S manufactured by Toa Denpa Kogyo K.K.)

pH: 8.4.

SBR Latexes having different Tg were prepared in the same manner by appropriately changing the ratio between styrene and butadiene.

Preparation of Coating Solutions 1A to 10 for Emulsion Layer (Photosensitive Layer)

1,000 g of each of Organic Silver Salt Dispersions A to O prepared above, 125 ml of water, 113 g of Reducing Agent 1 Dispersion, 91 g of Reducing Agent 2 Dispersion, 27 g of Pigment 1 Dispersion, 82 g of Organic Polyhalogen Compound 1 Dispersion, 40 g of Organic Polyhalogen Compound 2 Dispersion, 173 g of Phthalazine Compound 1 Solution, 1,082 g of SBR latex (Tg: 20.5° C.) solution and 9 g of Aqueous Mercapto Compound 1 Solution were sequentially added. Immediately before the coating, 158 g of Silver Halide Mixed Emulsion A for Coating Solution was added and thoroughly mixed. The obtained coating solution for emulsion layer was sent as it is to a coating die and coated.

The coating solution for emulsion layer obtained above was measured by B-Type Viscometer manufactured by Tokyo Keiki and found to have a viscosity of 85 [mPa.s] at 40° C. (No. 1 rotor, 60 rpm).

The viscosity of the coating solution at 25° C. was measured using RFS Field Spectrometer manufactured by Rheometrics Far East K.K. and found to be 1,500, 220, 70, 40 and 20 [mpa.s] at a shear rate of 0.1, 1, 10, 100, 1,000 [1/sec], respectively.

Preparation of Coating Solution 2 for Emulsion Layer Photosensitive Layer)

1,000 g of Organic Silver Salt Dispersion D prepared above, 104 ml of water, 30 g of Pigment 1 Dispersion, 21 g of organic Polyhalogen Compound 2 Dispersion, 69 g of Organic Polyhalogen Compound 3 Dispersion, 173 g of Phthalazine Compound 1 Solution, 1,082 g of SBR latex (Tg: 23° C.) solution, 258 g of Reducing Agent Complex 3 Dispersion and 9 g of Aqueous Mercapto Compound 1 Solution were sequentially added. Immediately before the coating, 110 g of Silver Halide Mixed Emulsion A for coating solution was added and thoroughly mixed. The obtained coating solution for emulsion layer was sent as it is to a coating die and coated.

Preparation of Coating Solution 3 for Emulsion Layer (Photosensitive Layer)

1,000 g of Organic Silver Salt Dispersion J prepared above, 95 ml of water, 73 g of Reducing Agent 4 Dispersion, 68 g of Reducing Agent 5 Dispersion, 30 g of Pigment 1 Dispersion, 21 g of Organic Polyhalogen Compound 2 Dispersion, 69 g of Organic Polyhalogen Compound 3 Dispersion, 173 g of Phthalazine Compound 1 Solution, 1,082 g of SBR core/shell type latex (core having Tg of 20° C./shell having Tg of 30° C.=70/30 by weight) solution, 124 g of Hydrogen Bond-Forming Compound 2 Dispersion and 9 g of Aqueous Mercapto Compound 1 Solution were sequentially added. Immediately before the coating 1 of Silver Halide Mixed Emulsion A for coating solution was added and thoroughly mixed. The obtained coating solution for emulsion layer was sent as it is to a coating die and coated.

Preparation of Coating Solution for Interlayer on Emulsion Surface

To 772 g of a 10% by mass aqueous solution of polyvinyl alcohol PVA-205 (produced by Kuraray Co., Ltd.), 5.3 g of a 20% by mass dispersion of pigment and 226 g of a 27.5% by mass solution of methyl methacrylate/styrene/butyl acrylate/hydroxyethyl methacrylate/acrylic acid copolymer (copolymerization weight ratio: 64/9/20/5/2) latex, 2 ml of a 5% by mass aqueous solution of Aerosol OT (produced by American Cyanamide), 10.5 ml of a 20% by mass aqueous solution of ammonium phthalate and water for making a total amount of 880 g were added to prepare a coating solution for interlayer and the resulting solution was adjusted to a pH 7.5 with NaOH and transferred to a coating die to give a coverage of 10 ml/m².

The viscosity of the coating solution measured by B-Type Viscometer at 40° C. (No. 1 rotor, 60 rpm) was 21 [mPa.s].

Preparation of Coating Solution for Protective First Layer on Emulsion Surface

64 g of inert gelatin was dissolved in water and thereto, 80 g of a 27.5% by mass solution of methyl methacrylate/styrene/butyl acrylate/hydroxyethyl methacrylate/acrylic acid copolymer (copolymerization weight ratio: 64/9/20/5/2) latex, 23 ml of a 10% by mass methanol solution of phthalic acid, 23 ml of a 10% by mass aqueous solution of 4-methylphthalic acid, 28 ml of sulfuric acid in a concentration of 0.5 mol/L, 5 ml of a 5% by mass aqueous solution of Aerosol OT (produced by American Cyanamide), 0.5 g of phenoxyethanol, 0.1 g of benziso-thiazolinone and water for making a total amount of 750 g were added to prepare a coating solution. Immediately before the coating, 26 ml of a 4% by mass chrome alum was mixed in a static mixer and the coating solution was transferred to a coating die to give a coverage of 18.6 ml/m².

The viscosity of the coating solution measured by B-Type Viscometer at 40° C. (No. 1 rotor, 60 rpm) was 17 [mPa.s].

Preparation of Coating Solution for the Protective Second Layer on Emulsion Surface

80 g of inert gelatin was dissolved in water and thereto, 102 g of a 27.5% by mass solution of methyl methacrylate/styrene/butyl acrylate/hydroxyethyl methacrylate/acrylic acid copolymer (copolymerization weight ratio: 64/9/20/5/2) latex, 3.2 ml of a 5% by mass solution of fluorine-containing surfactant (F-1: N-perfluoro-octylsulfonyl-N-propylalanine potassium salt), 32 ml of a 2% by mass aqueous solution of fluorine-containing surfactant (F-2: polyethylene glycol mono(N-perfluorooctylsulfonyl-N-propyl-2-aminoethyl ether [ethylene oxide average polymerization degree; 15]), 23 ml of a 5% by mass aqueous solution of Aerosol OT (produced by American Cyanamide), 4 g of polymethyl methacrylate fine particles (average particle size: 0.7 μm), 21 g of polymethyl methacrylate fine particles (average particle size: 4.5 μm), 1.6 g of 4-methylphthalic acid, 4.8 g of phthalic acid, 44 ml of sulfuric acid in a concentration of 0.5 mol/L, 10 ml of benzoisothiazolinone and water for making a total amount of 650 g were added. Immediately before the coating, 445 ml of an aqueous solution containing 4% by mass of chrome alum and 0.67% by mass of phthalic acid was mixed in a static mixer and the obtained coating solution for surface protective layer was transferred to a coating die to give a coverage of 8.3 ml/m².

The viscosity of the coating solution measured by B-Type Viscometer at 40° C. (No. 1 rotor, 60 rpm) was 9 [mPa.s].

Manufacture of Heat-developable Photosensitive Materials 1A to 1O

On the back surface of the undercoated support prepared above, the coating solution for antihalation layer and the coating solution for back surface protective layer were simultaneously coated such that the antihalation layer had a solid fine particle dye coated amount of 0.04 g/m² in terms of solid content and the, back surface protective layer had a gelatin coated amount of 1.7 g/m². Then, the coating was dried to form a back layer.

On the surface opposite the back surface, an emulsion layer (photosensitive layer), an interlayer, a protective first layer and a protective second layer in this order from the undercoated surface were simultaneously coated one on another by the slide bead coating method to manufacture a heat-developable photosensitive material sample. At this time, the temperature control was performed such that the emulsion layer and the interlayer were at 31° C., the protective first layer was at 36° C. and the protective second layer was 37° C.

The coated amount (g/m²) of each compound in respective emulsion layers formed using Coating Solutions 1A to 1O for Emulsion Layer (Photosensitive Layer) is shown below.

| | |
|---|---|
| Each of Organic Silver Salts A to O | 6.19 |
| Reducing Agent 1 | 0.67 |
| Reducing Agent 2 | 0.54 |
| Pigment (C.I. Pigment Blue 60) | 0.032 |
| Organic Polyhalogen Compound 1 | 0.46 |
| Organic Polyhalogen Compound 2 | 0.25 |
| Phthalazine Compound 1 | 0.21 |
| SBR Latex | 11.1 |
| Mercapto Compound 1 | 0.002 |
| Silver halide (as Ag) | 0.145 |

The coating and drying conditions were as follows.

The coating was performed at a speed of 160 m/min, the distance between the tip of coating die and the support was set to 0.10 to 0.30 mm and the pressure in the decompression chamber was set 196 to 882 Pa lower than the atmospheric pressure. The support was de-electrified by ion blowing before the coating.

In the subsequent chilling zone, the coating solution was cooled by the blowing at a dry bulb temperature of 10 to 20° C. and thereafter, the sample was transported by non-contact means and dried with drying air at a dry bulb temperature of 23 to 45° C. and a wet bulb temperature of 15 to 21° C. in a helical non-contact type drying apparatus.

After the drying, the humidity conditioning was performed at 25° C. and a humidity of 40 to 60% RH and then, the layer surface was heated to 70 to 90° C. The heated layer surface was then cooled to 25° C.

The thus-manufactured heat-developable photosensitive material had a matting degree of, in terms of the Beck smoothness, 550 seconds on the photosensitive layer surface and 130 seconds on the back surface. Furthermore, the pH on the layer surface in the photosensitive layer side was measured and found to be 6.0.

Manufacture of Heat-developable Photosensitive Material 2

Heat-developable Photosensitive Material 2 was manufactured in the same manner as Heat-developable Photosensitive Material 1 except that in Heat-developable Photosensitive Material 1, Coating Solution 1 for Emulsion Layer (Photosensitive Layer) was changed to Coating Solution 2 for Emulsion Layer (Photosensitive Layer) and Yellow Dye Compound 15 was excluded from the antihalation layer.

At this time, the coated amount (g/m²) of each compound in the emulsion layer was as follows.

| | |
|---|---|
| Organic Silver Salt D | 6.19 |
| Pigment (C.I. Pigment Blue 60) | 0.036 |
| Organic Polyhalogen Compound 2 | 0.13 |
| Organic Polyhalogen Compound 3 | 0.41 |
| Phthalazine Compound 1 | 0.21 |
| SBR Latex | 11.1 |
| Reducing Agent Complex 3 | 1.54 |
| Mercapto Compound 1 | 0.002 |
| Silver halide (as Ag) | 0.10 |

Manufacture of Heat-developable Photosensitive Material 3

Heat-developable Photosensitive Material 3 was manufactured in the same manner as Heat-developable Photosensitive Material 1 except that in Heat-developable Photosensitive Material 1, Coating Solution 1 for Emulsion Layer (Photosensitive Layer) was changed to Coating Solution 3 for Emulsion Layer (Photosensitive Layer), Yellow Dye Compound 15 was excluded from the antihalation layer, and Fluorine-Containing Surfactants F-1, F-2, F-3 and F-4 in the protective second layer and the back surface protective layer were changed to equal weights of P-5, F-6, F-7 and F-8, respectively.

At this time, the coated amount (g/m²) of each compound in the emulsion layer was as follows.

| | |
|---|---|
| Organic Silver Salt J | 5.57 |
| Pigment (C.I. Pigment Blue 60) | 0.032 |
| Reducing Agent 4 | 0.40 |
| Reducing Agent 5 | 0.36 |
| Organic Polyhalogen Compound 2 | 0.12 |
| Organic Polyhalogen Compound 3 | 0.37 |
| Phthalazine Compound 1 | 0.19 |
| SBR Latex | 10.0 |
| Hydrogen Bond-Forming Compound 2 | 0.59 |
| Mercapto Compound 1 | 0.002 |
| Silver halide (as Ag) | 0.09 |

Manufacture of Heat-developable Photosensitive Material 4

Heat-developable Photosensitive Material 4 was manufactured using Organic Silver Salt D of Heat-developable Photosensitive Material 1 by changing the amount of pigment added to 0.

Chemical structures of the compounds used in Examples of the present invention are set forth below.

Spectral Sensitizing Dye A

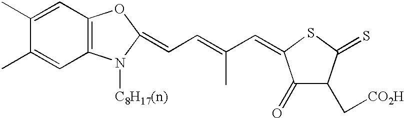

Spectral Sensitizing Dye B

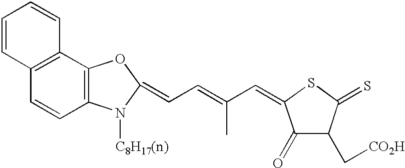

Tellurium Sensitizer C

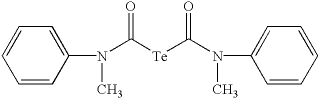

Base Precursor Compound 11

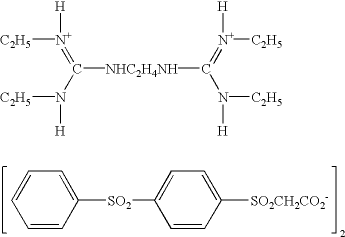

Cyanine Dye Compound 13

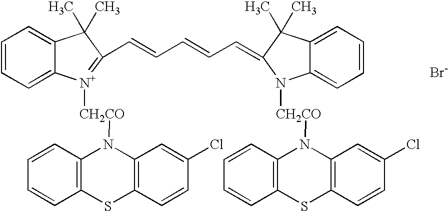

Blue Dye Compound 14

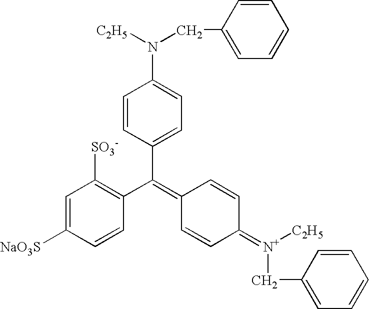

Yellow Dye Compound 15

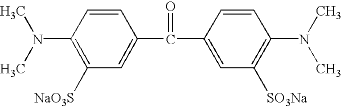

Reducing Agent 1

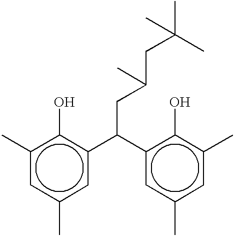

Reducing Agent 2

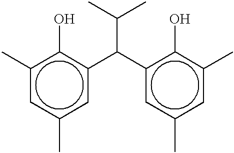

Reducing Agent Complex 3

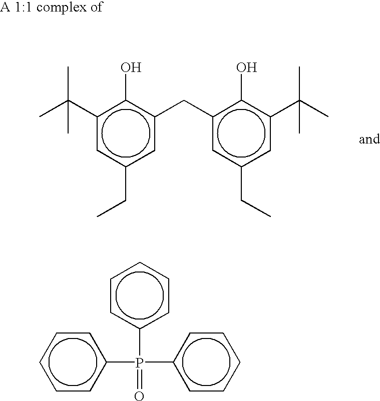

Reducing Agent 4

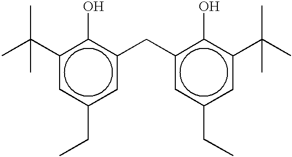

Reducing Agent 5

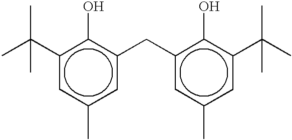

Hydrogen Bond-Forming Compound 2

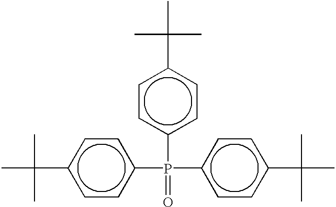

Organic Polyhalogen Compound 1

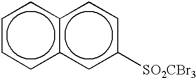

Organic Polyhalogen Compound 2

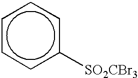

Organic Polyhalogen Compound 3

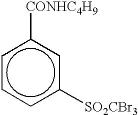

Mercapto Compound 1

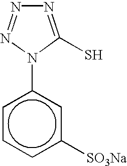

Phthalazine Compound 1

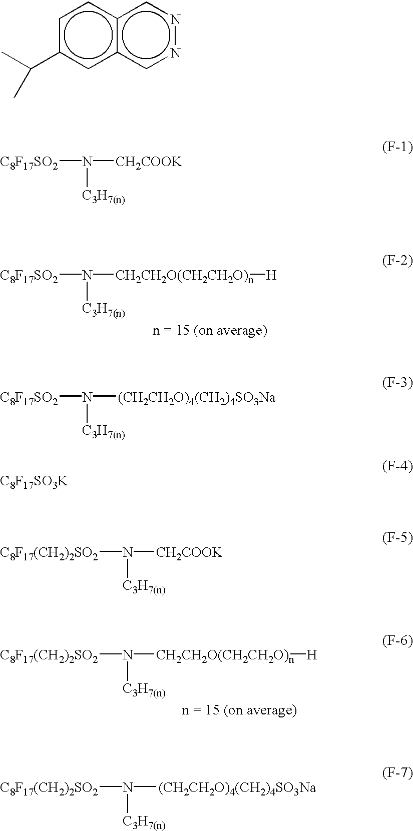

C₈F₂₇(CH₂)₂SO₃K (F-8)

Evaluation of Photographic Performance

Each photographic material was exposed and heat-developed (with 4 sheets of panel heater set to 112° C.-119° C.-121° C.-121° C. for 24 seconds in total) by Fuji Medical Dry Laser Imager FM-DP L (mounted with a 660 nm semiconductor laser having a maximum output of 60 mW (IIIB)). The obtained image was evaluated by a densitometer. The results are shown in Table 2.

Evaluation of Image Preservability

Each photographic material was exposed and heat-developed (with 4 sheets of panel heater set to 112° C.-119° C.-121° C.-121° C. for 24 seconds in total) by Fuji Medical Dry Laser Imager FM-DP L (mounted with a 660 nm semiconductor laser having a maximum output of 60 mW (IIIB)) Thereafter, each material was thoroughly irradiated with light, subjected to humidity conditioning at 70% RH for 3 hours, sealed in a bag capable of shielding light and allowed to stand in an environment at 60° C. for 24 hours. The change rate of Dmin here is shown in Table 2.

TABLE 2

| Heat- | | Change in | |
|---|---|---|---|
| developable | | Percentage of | |
| Photosensitive | Dmin | Image | |
| Material | (1D as 100) | Preservability (%) | Remarks |
| 1A | 106 | 45 | Comparison |
| 1B | 107 | 30 | Invention |
| 1C | 103 | 12 | Invention |
| 1D | 100 | 0 | Invention |
| 1E | 110 | 89 | Comparison |
| 1F | 103 | 12 | Invention |
| 1G | 106 | 45 | Comparison |
| 1H | 107 | 53 | Comparison |
| 1I | 103 | 12 | Invention |
| 1J | 100 | 0 | Invention |
| 1K | 106 | 25 | Invention |
| 1L | 106 | 47 | Comparison |
| 1M | 102 | 8 | Invention |
| 1N | 99 | 0 | Invention |
| 1O | 104 | 22 | Invention |
| 2 | 100 | 0 | Invention |
| 3 | 100 | 0 | Invention |
| 4 | 94 | 0 | Invention |

According to the present invention, a heat-developable photosensitive material favored with low Dmin and excellent image preservability can be provided.

While the invention has been described in detail and with reference to specific embodiments thereof, it will be apparent to one skilled in the art that various changes and modifications can be made therein without departing from the spirit and scope thereof.

The entire disclosure of each and every foreign patent application from which the benefit of foreign priority has been claimed in the present application is incorporated herein by reference, as if fully set forth.

What is claimed is:

1. A heat-developable image recording material comprising
a support;
a photosensitive silver halide;
a reducing agent for a silver ion;
a binder; and
a non-photosensitive organic silver salt grain,
wherein the non-photosensitive organic silver salt grain has:
1) a silver stearate content of 1 mol % or less;
2) a length/width ratio of 1 to 9;
3) an aspect ratio of 1.1 to 30; and
4) an equivalent-sphere diameter of 0.05 to 1 μm.

2. The heat-developable image recording material as claimed in claim 1, wherein the non-photosensitive organic silver salt grain has a silver arachidate content of 6 mol % or less.

3. The heat-developable image recording material as claimed in claim 17 wherein the non-photosensitive organic silver salt grain has a silver behenate content of 90 to 100 mol %.

4. The heat-developable image recording material as claimed in claim 1, wherein the non-photosensitive organic silver salt grain has a silver behenate content of 95 to 100 mol %.

5. The heat-developable image recording material as claimed in claim 1, wherein the non-photosensitive organic silver salt grain has a silver behenate content of 97 to 100 mol %.

6. The heat-developable image recording material as claimed in claim 1, wherein the non-photosensitive organic silver salt grain is prepared at 60° C. or less.

7. The heat-developable image recording material as claimed in claim 1, wherein the non-photosensitive organic silver salt grain is prepared by adding an aqueous silver nitrate solution and a solution or suspension of an organic acid alkali metal salt to a closed mixing vessel.

8. The heat-developable image recording material as claimed in claim 1, wherein the non-photosensitive organic silver salt grain is desalted by an ultrafiltration.

9. The heat-developable image recording material as claimed in claim 1, which further comprises an image-forming layer containing the photosensitive silver halide and the non-photosensitive organic silver salt grain.

10. Th heat-developable image recording material as claimed in claim 9, wherein the image-forming layer further contains the reducing agent for a silver ion and the binder.

11. The heat-developable image recording material as claimed in claim 9, which further comprises a second image-forming layer containing the reducing agent for a silver ion and the binder.
